(19) United States
(12) Patent Application Publication
(10) Pub. No.: US 2017/0163826 A1
(43) Pub. Date: Jun. 8, 2017

(54) INFORMATION PROCESSING APPARATUS, IMAGE PROCESSING APPARATUS, INFORMATION PROCESSING SYSTEM, AND SCREEN DISPLAY METHOD

(71) Applicants: Keisuke Nakazawa, Kanagawa (JP); Miki Hashimoto, Kanagawa (JP); Hiroya Uruta, Tokyo (JP); Yuto Shibata, Kanagawa (JP); Tomoki Shibukawa, Tokyo (JP)

(72) Inventors: Keisuke Nakazawa, Kanagawa (JP); Miki Hashimoto, Kanagawa (JP); Hiroya Uruta, Tokyo (JP); Yuto Shibata, Kanagawa (JP); Tomoki Shibukawa, Tokyo (JP)

(73) Assignee: Ricoh Company, Ltd., Tokyo (JP)

(21) Appl. No.: 15/369,621

(22) Filed: Dec. 5, 2016

(30) Foreign Application Priority Data
Dec. 7, 2015 (JP) 2015238812
May 2, 2016 (JP) 2016092721

(51) Int. Cl. H04N 1/00

(52) U.S. Cl. CPC H04N 1/00506; H04N 1/00482; H04N 1/00832; H04N 2201/0094

(57) ABSTRACT

An information processing apparatus includes circuitry configured to: acquire process history data indicating a setting of one or more setting items, as a history of process executed based on the setting of the one or more setting items that are set on a setting screen in which one or more display parts to enable setting of the one or more setting items are arranged; calculate a use frequency of each of the one or more setting items based on the acquired process history data; and display a setting screen in which the one or more display parts are rearranged based on the use frequency of each of the one or more setting items, on a display.

### CROSS-REFERENCE TO RELATED APPLICATIONS

The present application claims priority under 35 U.S.C. §119 to Japanese Patent Application No. 2015-238812, filed Dec. 7, 2015 and Japanese Patent Application No. 2016-092721, filed May 2, 2016. The contents of which are incorporated herein by reference in their entirety.

### BACKGROUND OF THE INVENTION

1. Field of the Invention

The present invention relates to an information processing apparatus, an image processing apparatus, an image processing system, and a screen display method.

2. Description of the Related Art

Conventionally, in image processing apparatuses, such as a multifunction peripheral (MFP), image processing such as copying is performed according to respective settings of one or more setting items. The setting item can be various items, such as color, scaling, and print quantity.

In such an image processing apparatus, a technique of displaying a setting screen in which one or more display parts are arranged to enable setting of one or more setting items, to let a user to make (change when initial setting has been made) setting of the setting items as above has been known.

For example, Japanese Laid-open Patent Publication No. 2010-268346 discloses a technique of displaying, in an image forming system, a screen that includes a region in which software buttons to enable setting of multiple functions executable in the image forming system are arranged, and a region for recommended functions in which three software buttons to enable setting of three frequently-used functions that are used in combination with a function selected by a user are arranged in descending order of frequency. In the technique disclosed in the patent literature, the three frequently-used functions that are used in combination with a function selected by a user are identified based on a use history of functions.

However, the conventional technique described above is to recommend a setting item having a high possibility of being used in combination with a setting item selected by a user but not to recommend a setting item having a high possibility of being used by a user.

Moreover, in the conventional technique described above, as display parts of setting items recommended to a user are arranged in addition to display parts that have originally been arranged in a setting screen, the number of display parts arranged in the setting screen increases, and degradation in visibility of the setting screen is a concern.

### SUMMARY OF THE INVENTION

According to one aspect of the present invention, an information processing apparatus includes circuitry. The circuitry is configured to acquire process history data indicating a setting of one or more setting items, as a history of process executed based on the setting of the one or more setting items that are set on a setting screen in which one or more display parts to enable setting of the one or more setting items are arranged. The circuitry is further configured to calculate a use frequency of each of the one or more setting items based on the acquired process history data. The circuitry is further configured to display a setting screen in which the one or more display parts are rearranged based on the use frequency of each of the one or more setting items, on a display.

### BRIEF DESCRIPTION OF THE DRAWINGS

FIG. 1 is a schematic diagram illustrating one example of a hardware setting of an image processing apparatus of a first embodiment;

FIG. 2 is a schematic diagram illustrating one example of a software setting of the image processing apparatus of the first embodiment;

FIG. 3 is a block diagram illustrating one example of a functional setting of an operation unit of the first embodiment;

FIG. 4 illustrates one example of a setting screen of the first embodiment;

FIG. 5 is an explanatory diagram of one example of an arrangement rule of the first embodiment;

FIG. 6 illustrates one example of process history data that is stored in a process-history-data storage unit of the first embodiment;

FIG. 7 illustrates one example of priorities of setting items of the first embodiment;

FIG. 8 illustrates one example of priorities of setting items of the first embodiment;

FIG. 9 illustrates one example of a setting screen of the first embodiment;

FIG. 10 illustrates one example of a user setting screen of the first embodiment;

FIG. 11 is a flowchart illustrating one example of display processing performed by the operation unit of the first embodiment;

FIG. 12 illustrates one example of process history data that is stored in a process-history-data storage unit of a first modification;

FIG. 13 illustrates one example of priorities of setting items of the first modification;

FIG. 14 illustrates one example of a setting screen of the first modification;

FIG. 15 illustrates one example of priorities of setting items of second modification;

FIG. 16 illustrates one example of a setting screen of the second modification;

FIG. 17 illustrates one example of priorities of setting items of a third modification;

FIG. 18 illustrates one example of a setting screen of the third modification;

FIG. 19 illustrates a setting screen of a fourth modification;

FIG. 20 illustrates one example of a selection screen of the fourth modification;

FIG. 21 illustrates one example of a setting screen of the fourth modification;

FIG. 22A is a schematic diagram illustrating one example of a configuration of a system of a fifth modification;

FIG. 22B is a schematic diagram illustrating one example of a hardware configuration of a server device of the fifth modification;

FIG. 23 illustrates one example of process history data that is stored in a process-history-data storage unit of the fifth modification;

FIG. 24 is a block diagram illustrating one example of a functional configuration of an operation unit of a second embodiment;

FIG. 25 illustrates one example of condition information that is stored in a condition-information storage unit of the second embodiment;

FIG. 26 illustrates one example of priorities of setting items of the second embodiment;

FIG. 27 illustrates one example of a setting screen of the second embodiment;

FIG. 28 illustrates one example of a use setting screen of the second embodiment;

FIG. 29 illustrates one example of a user setting screen of the second embodiment;

FIG. 30 illustrates a comparison example of a user setting screen illustrated in FIG. 31;

FIG. 31 illustrates one example of a user setting screen of the second embodiment;

FIG. 32 illustrates a comparison example of a user setting screen illustrated in FIG. 33;

FIG. 33 illustrates one example of a user setting screen of the second embodiment;

FIG. 34 is a flowchart illustrating one example of display processing performed by the operation unit of the second embodiment;

FIG. 35 is a flowchart illustrating one example of display processing performed by an operation unit of a sixth modification;

FIG. 36 illustrates one example of a home screen of the sixth modification;

FIG. 37 illustrates one example of a rearrangement-necessity selection screen of the sixth modification;

FIG. 38 illustrates one example of a rearrangement-execution-mode selection screen of a seventh modification;

FIG. 39 is a flowchart illustrating one example of display processing performed by the operation unit of the seventh modification;

FIG. 40 is a block diagram illustrating one example of a functional configuration of an operation unit of an eighth modification;

FIG. 41 illustrates one example of a rearrangement-execution-timing selection screen of the eighth modification; and

FIG. 42 is a flowchart illustrating one example of display processing performed by the operation unit of the eighth modification.

The accompanying drawings are intended to depict exemplary embodiments of the present invention and should not be interpreted to limit the scope thereof. Identical or similar reference numerals designate identical or similar components throughout the various drawings

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments of an information processing apparatus, an image processing apparatus, an information processing system, and a screen display method according to the present invention are explained in detail below with reference to the accompanying drawings. Although explanation is given with a case of the image processing apparatus being a multifunction peripheral (MFP) as an example in the respective embodiments below, the image processing apparatus is not limited thereto. The MPF is an apparatus that includes at least two functions out of a print function, a copy function, a scanner function, and a facsimile function.

An embodiment has an object to provide an information processing apparatus, an image processing apparatus, an information processing system, and a screen display method that are capable of recommending a setting item having a high possibility of being used by a user, while suppressing degradation of visibility of a setting screen.

### First Embodiment

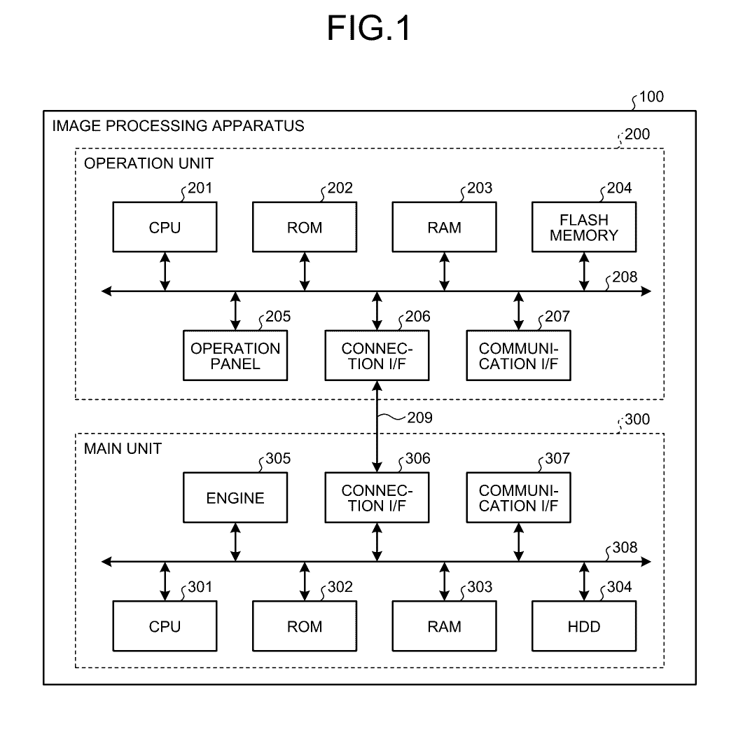

FIG. 1 is a schematic diagram illustrating one example of a hardware setting of an image processing apparatus 100 of a first embodiment. As illustrated in FIG. 1, the image processing apparatus 100 includes a main unit 300 and an operation unit 200. That is, the image processing apparatus 100 can be regarded as an information processing system that includes the main unit 300 and the operation unit 200. Although explanation is given with a case of the information processing apparatus being the operation unit 200 as an example in the first embodiment, the image processing apparatus is not limited thereto.

The main unit 300 and the operation unit 200 are connected through a dedicated communication path 209 so as to be able to communicate with each other. As the communication path 209, for example, one of a universal serial bus (USB) standard can be used. The communication path 209 can be either wired or wireless. Moreover, the communication path 209 can also be a network such as the Internet, a telephone line, or the like.

Although the example illustrated in FIG. 1 illustrates a case in which the number of the operation unit 200 connected to the main unit 300 is one, the number is not limited thereto and an arbitrary number of operation units 200 may be provided. Similarly, the example illustrated in FIG. 1 illustrates a case in which the number of main unit 300 connected to the operation unit 200 is one, the number of the main unit 300 is not limited thereto, and can be any number.

The main unit 300 includes a central processing unit (CPU) 301, a read-only memory (ROM) 302, a random-access memory (RA) 303, a hard disk drive (HDD) 304, an engine 305, a connection interface (I/F) 306, and a communication I/F 307. The CPU 301, the ROM 302, the RAM 303, the HDD 304, the engine 305, the connection I/F 306, and the communication I/F 307 are connected to each other through a system bus 308.

The engine 305 is to perform various kinds of functions such as a copy function, a scanner function, a facsimile function, a printer function, and the like, and is hardware that performs general information processing and processing other than communication to implement these functions. The engine 305 includes, for example, a scanner that reads an image of an original, a plotter that performs printing onto a sheet material such as a paper sheet, a facsimile unit that performs facsimile communications, and the like. The engine 305 can further include specific options, such as a finisher that sorts printed sheet materials, and an auto document feeder (ADF) that automatically conveys originals.

The CPU 301 controls overall operation of the main unit 300. The CPU 301 executes a program that is stored in the ROM 302, the HDD 304, or the like using the RAM 303 as a work area. Thus, the CPU 301 controls overall operation of the main unit 300. That is, the CPU 301 causes the engine 305 to perform the copy function, the scanner function, the facsimile function, the printer function, and the like described above.

The connection I/F 306 is an interface to communicate with the operation unit 200 through the communication path 209. The communication I/F 307 is an interface to communicate with an external device through a network.

Next, the operation unit 200 is explained. The operation unit 200 accepts an input according to an operation made by a user. Furthermore, the operation unit 200 displays various kinds of images (screens). The operation unit 200 has a specific operating system (OS) and a screen transition mechanism. Note that the main unit 300 performs an operation according to the input accepted by the operation unit 200.

The operation unit 200 includes a CPU 201, a ROM 202, a RAM 203, a flash memory 204, an operation panel 205 (one example of a display unit), a connection I/F 206, and a communication I/F 207. The CPU 201, the ROM 202, the RAM 203, the flash memory 204, the operation panel 2095, the connection I/F 206, and the communication I/F 207 are connected to each other through a system bus 208.

The CPU 201 controls overall operation of the operation unit 200. The CPU 201 executes a program that is stored in the ROM 202, the flash memory 204, or the like using the RAM 203 as a work area to control overall operation of the operation unit. By this execution of the program, the CPU 201 implements various functions described later.

The connection I/F 206 is an interface to communicate with the main unit 300 through the communication path 209. The communication I/F 207 is an interface to communicate with an external device through a network.

The operation panel 205 accepts various kinds of inputs according to an operation made by a user, and displays various kinds of images (screens). Although explanation is given with a case in which the operation panel 205 is a touch panel that has both an accepting function to accept various kinds of inputs and a display function to display various kinds of images (screens) in one unit in the first embodiment, the operation panel 205 is not limited thereto. For example, the operation panel 205 can be configured with an input device to accept various kinds of inputs and a display device that displays various kinds of data as separate units.

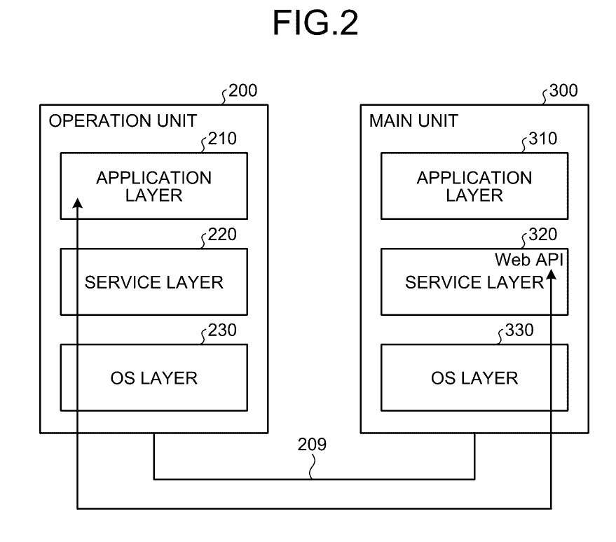

Next, a software setting of the image processing apparatus 100 is explained. FIG. 2 is a schematic diagram illustrating one example of a software setting of the image processing apparatus 100 of the first embodiment.

The main unit 300 has an application layer 310, a service layer 320, and an OS layer 330. The substances of the application layer 310, the service layer 320, and the OS layer 330 are various kinds of software stored in the ROM 302, the HDD 304, and the like. The CPU 301 executes the software, thereby providing various kinds of functions.

The software of the application layer 310 is an application program (simply referred to as “app” in the following explanation, in some cases) to activate a hardware resource to provide a predetermined function. For example, the app can be a copier app to provide the copier function, a scanner app to provide the scanner function, the facsimile app to provide the facsimile function, the printer app to provide the printer function, and the like.

The software of the service layer 320 is present between the application layer 310 and the OS layer 330, and is software to provide, to the app, an interface to use a hardware resource in the main unit 300. More specifically, the software is to provide a function of accepting an operation request to a hardware resource, and of arbitrating an operation request. The operation request accepted by the service layer 320 can be a request of read by a scanner, print by a plotter, and the like.

The interface function by the service layer 320 is provided not only to the application layer 310 of the main unit 300, but also to an application layer 210 of the operation unit 200. For example, the interface function of WebAPI of the service layer is provided by WebAPI. That is, the application layer 210 (app) of the operation unit 200 can also implement a function using a hardware resource (for example, the engine 305) of the main unit 300 through the interface function of WebAPI of the service layer 320.

The software of the OS layer 330 is basic software (operating system) to provide a basic function of controlling hardware in the main unit 300. The software of the service layer 320 converts a use request of a hardware resource from various kinds of apps into a command readable by the OS layer 330, to transfer to the OS layer 330. The command is then executed by the software of the OS layer 330, and the hardware resource thereby performs an operation according to the request from the app.

Similarly, the operation unit 200 has the application layer 210, a service layer 220, and an OS layer 230. The application layer 210, the service layer 220, and the OS layer 230 in the operation unit 200 also have the same hierarchical structure as of the main unit 300. However, a function provided by the app of the application layer 210, or a type of an operation request acceptable by the service layer 220 differ from the main unit 300.

The app of the application layer 210 can be software to provide a hardware resource in the operation unit 200 to provide a predetermined function. The app of the application layer 210 is mainly software to provide a function of a user interface (UI) to performs operation and display relating to a function of the main unit 300. The function of the main unit 300 can be, for example, the copy function, the scanner function, the facsimile function, the printer function, and the like.

In the first embodiment, to maintain independence of functions, the software of the OS layer 330 of the main unit 300 and the software of the OS layer 230 of the operation unit 200 differ from each other. That is, the main unit 300 and the operation unit 200 operate with separate operating systems independently of each other. For example, it is possible to use Linux (registered trademark) as the software of the OS layer 330 of the main unit 300, and Android (registered trademark) as the software of the OS layer 230 of the operation unit 200.

As described, in the first embodiment, the main unit 300 and the operation unit 200 operate with separate operating systems. Therefore, the communication between the main unit 300 and the operation unit 200 is not performed as an inter-process communication inside a shared device, but as a communication between different devices. Processing (command communication) of transferring an input (instruction from a user) accepted by the operation unit 200 to the main unit 300, and processing of informing an event to the operation unit 200 by the main unit 300, and the like correspond to this communication. In the first embodiment, the operation unit 200 performs the command communication to the main unit 300, thereby being able to use a function of the main unit 300. Moreover, the event informed to the operation unit 200 from the main unit 300 can include an execution state of an operation in the main unit 300, a setting made in the main unit 300, and the like.

Moreover, in the first embodiment, a case in which power supply to the operation unit 200 is performed through the communication path 209 from the main unit 300 is explained as an example. However, the power supply is not limited thereto, and power source control of the operation unit 200 can be performed separately from (independently of) power source control of the main unit 300.

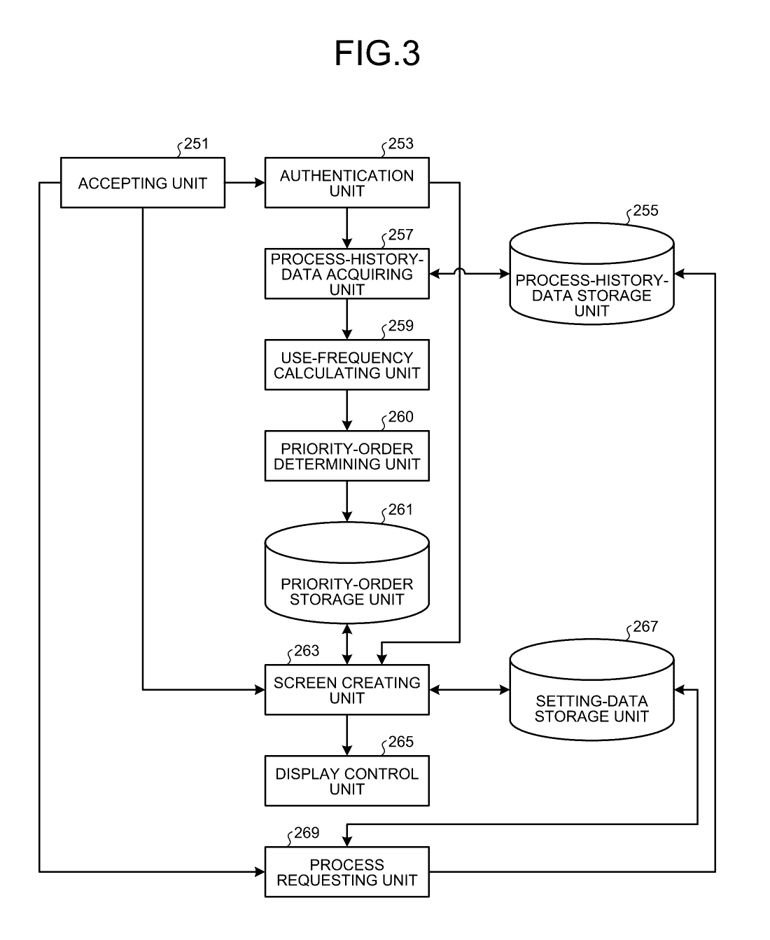

Next, a functional setting of the image processing apparatus 100 is explained. In the following, functions relating to display processing that is performed in the image processing apparatus 100 are mainly explained. FIG. 3 is a block diagram illustrating one example of a functional configuration of the operation unit 200 of the first embodiment.

As illustrated in FIG. 3, the operation unit 200 includes an accepting unit 251, an authentication unit 253, a process-history-data storage unit 255, a process-history-data acquiring unit 257, a use-frequency calculating unit 259, a priority-order determining unit 260, a priority-order storage unit 261, a screen creating unit 263, a display control unit 265, a setting-data storage unit 267, and a process requesting unit 269.

The accepting unit 251, the authentication unit 253, the process-history-data acquiring unit 257, the use-frequency calculating unit 259, the priority-order determining unit 260, the screen creating unit 263, the display control unit 265, and the process requesting unit 269 can be implemented as software by executing a program stored in the ROM 202 by the CPU 201 on the RAM 203.

Note that the accepting unit 251, the authentication unit 253, the process-history-data acquiring unit 257, the use-frequency calculating unit 259, the priority-order determining unit 260, the screen creating unit 263, the display control unit 265, and the process requesting unit 269 can be implemented as hardware such as an integrated circuit (IC) and an application-specific integrated circuit (ASIC), or can be implemented as software and hardware in combination.

The process-history-data storage unit 255, the priority-order storage unit 261, and the setting-data storage unit 267 can be implemented by, for example, the flash memory 204, the RAM 203, and the like.

The accepting unit 251 accepts various kinds of inputs from the operation panel 205. The input from the operation panel 205 accepted by the accepting unit 251 can include, for example, a login input for a user to log into the image processing apparatus 100, and a selection input to select a display part displayed on the operation panel 205, but is not limited thereto.

The login input is, for example, authentication information such as a set of an identification (ID) and a password input to the operation panel 205 by a user, but is not limited thereto. For example, if the operation unit 200 has an IC card reader, identification information of an IC card read by the IC card reader, or a PIN code can be a login input, to be accepted by the accepting unit 251.

When a login input is accepted by the accepting unit 251, the authentication unit 253 performs login authentication of a user based on the accepted login input. The authentication unit 253 can perform login authentication by the authentication unit 253 alone (the operation unit 200 alone), or can perform login authentication in cooperation with an external device. As the login authentication is a public knowledge, detailed explanation thereof is omitted, but there is, for example, a method of comparing a set of an ID and a password input as a login input, with a set of an ID and a password registered as master data in the flash memory 204 or in an external device. However, the authentication method is not limited thereto.

The process-history-data storage unit 255 stores process history data of processing performed based on a setting of one or more setting items that is set on a setting screen in which one or more display parts are arranged to enable setting of one or more setting items. The processing includes, for example, copying, scanning, facsimileing, and the like performed in the image processing apparatus 100, but is not limited thereto. The display part is only required to be an image indicating a setting item to be configured, such as an icon image and a widget image, and the type thereof is not specifically limited.

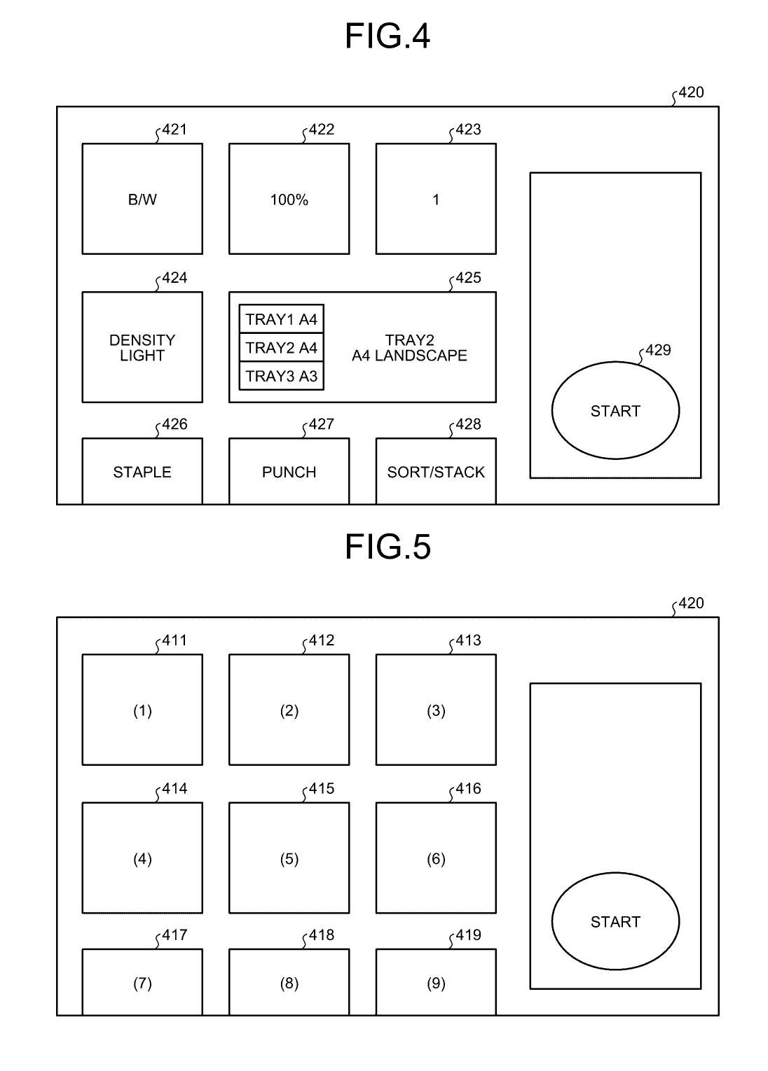

FIG. 4 illustrates one example of a setting screen 420 of the first embodiment, and illustrates the setting screen 420 that is displayed on the operation panel 205 to let a user make setting for copying when the image processing apparatus 100 is in an initial state (for example, when operation is started, or when initialization is performed). In the setting screen 420 illustrated in FIG. 4, display parts 421 to 428 are arranged.

The display part 421 is a display part to let a setting for a setting item “color” be made. For the setting item “color”, whether to perform copying in color or in black and white is set by a user operation. Although the initial setting for the setting item “color” is herein “black and white”, the initial setting is not limited thereto.

The display part 422 is a display part to let a setting for a setting item “scaling” be made. For the setting item “scaling”, a scaling factor in copying is set by a user operation. The initial setting for the setting item “scaling” herein is “100%”, but is not limited thereto.

The display part 423 is a display part to let a setting for a setting item “print quantity” be made. For the setting item “print quantity”, the number of copies is set by a user operation. The initial setting for the setting item “print quantity” herein is “1”, but is not limited thereto.

The display part 424 is a display part to let setting for a setting item “density” be made. For the setting item “density”, the density in copying is set by a user operation. The initial setting for the setting item “density” herein is “light”, but is not limited thereto.

The display part 425 is a display part to let setting for a setting item “tray” be made. For the setting item “tray”, a tray housing paper sheets to be used for copying is set. The initial setting for the setting item “tray” herein is “tray 2”, but is not limited thereto.

The display part 426 is a display part to let setting for a setting item “staple” be made. For the setting item “staple”, whether to staple after copying is set by a user operation. The initial setting for the setting item “staple” herein is “no”, but is not limited thereto.

The display part 427 is a display part to let setting for a setting item “punch” be made. For the setting item “punch”, whether punching process is to be done after copying is set by a user operation. The initial setting for the setting item “punch” herein is “no”, but is not limited thereto.

The display part 428 is a display part to let setting for a setting item “sort/stack” be made. For the setting item “sort/stack”, whether sorting/stacking process is to be done after copying is set by a user operation. The initial setting for the setting item “sort/stack” herein is “no”, but is not limited thereto.

The display parts 421 to 428 are arranged in order of priority in accordance with a predetermined arrangement rule. FIG. 5 is an explanatory diagram of one example of an arrangement rule of the first embodiment. In the arrangement rule illustrated in FIG. 5, a display part of a setting item having the highest priority (priority (1)) is prescribed to be arranged at a position 411 on the setting screen 420. Moreover, a display part of a setting item having the second highest priority (priority (2)) is prescribed to be arranged at a position 412 on the setting screen 420. Furthermore, a display part of a setting item having the third highest priority (priority (3)) is prescribed to be arranged at a position 413 on the setting screen 420. Moreover, a display part of a setting item having the fourth highest priority (priority (4)) is prescribed to be arranged at a position 414 on the setting screen 420. Furthermore, a display part of a setting item having the fifth highest priority (priority (5)) is prescribed to be arranged at a position 415 on the setting screen 420. Moreover, a display part of a setting item having the sixth highest priority (priority (6)) is prescribed to be arranged at a position 416 on the setting screen 420. Furthermore, a display part of a setting item having the seventh highest priority (priority (7)) is prescribed to be arranged at a position 417 on the setting screen 420. Moreover, a display part of a setting item having the eighth highest priority (priority (8)) is prescribed to be arranged at a position 418 on the setting screen 420. Furthermore, a display part of a setting item having the ninth highest priority (priority (9)) is prescribed to be arranged at a position 419 on the setting screen 420.

The display part 421 is arranged at the position 411, the display part 422 is arranged at the position 412, the display part 423 is arranged at the position 413, and the display part 424 is arranged at the position 414. Moreover, because an area of two positions is required to arrange the display part 425, display part 425 is arranged at the positions 415 and 416. Furthermore, the display part 426 is arranged at the position 417, the display part 427 is arranged at the position 418, and the display part 428 is arranged at the position 419.

Therefore, the priority order of the setting items in the initial state of the image processing apparatus 100 is the order or “color”, “scaling”, “print quantity”, “density”, “tray”, “staple”, “punch”, and the n ort/stack” as illustrated in FIG. 4.

In the first embodiment, to enable a user to grasp the priority order of the entire setting items that can be set on the setting screen 420 at a glance, and to enable to recommend a setting item having a higher priority than a setting item having lower priority to a user, the arrangement rule (a setting item having a higher priority is arrange at an upper portion rather than a lower portion in the setting screen 420, and is arranged on a left side rather than a right side of the setting screen 420) as described above is set. However, the arrangement rule is not limited thereto.

When a start key 429 is selected by a user operation on the setting screen 420 in FIG. 4, copying is performed based on the eight setting items (“color”, “scaling”, “print quantity”, “density”, “tray”, “staple”, “punch”, and “sort/stack”) that are set on the setting screen 420. In the process-history-data storage unit 255, process history data indicating the setting of one or more setting items (“color”, “scaling”, “print quantity”, “density”, “tray”, “staple”, “punch”, and “sort/stack”) is stored as a historic record of this copying.

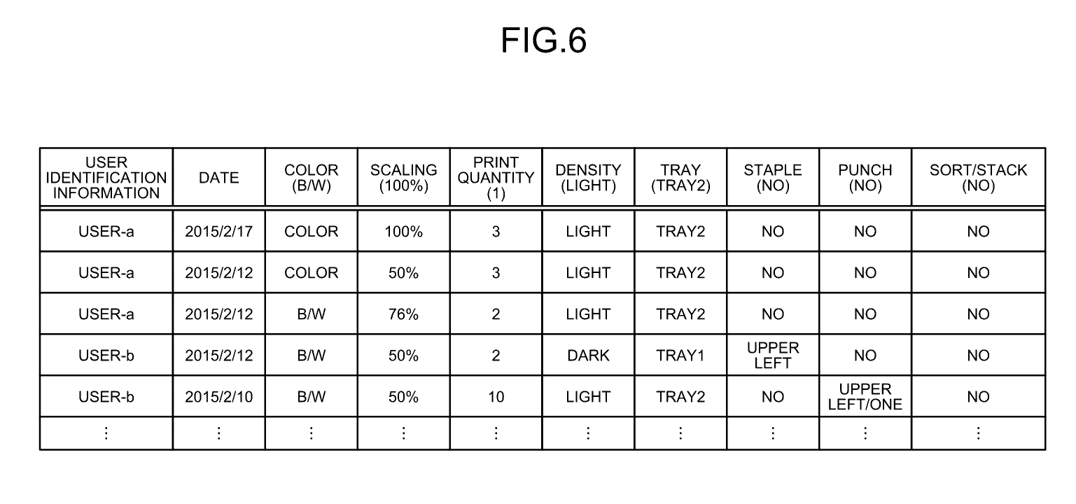

FIG. 6 illustrates one example of process history data that is stored in the process-history-data storage unit 255 of the first embodiment. In the example illustrated in FIG. 6, the process history data indicates user identification information, date, and settings of the respective setting items (“color”, “scaling”, “print quantity”, “density”, “tray”, “staple”, “punch”, and “sort/stack”).

The user identification information is an identifier of a user that is logged into the image processing apparatus 100 when the processing of process history data is performed, and includes, for example, an ID and name of the user, but is not limited thereto. The data indicates date of performance of the processing of the process history data. The respective setting items indicate setting values at the time when the processing of the process history data is performed. Note that values in brackets of the respective setting items indicate default values.

The process-history-data acquiring unit 257 acquires process history data. In the first embodiment, when login authentication of a user by the authentication unit 253 results successful, the process-history-data acquiring unit 257 acquires process history data that includes user identification information of the user from the process-history-data storage unit 255, but the configuration is not limited thereto. For example, process history data of all users may be acquired, or process history data within a predetermined period from date of successful login authentication may be acquired.

The use-frequency calculating unit 259 calculates a use frequency of each of the one or more setting items based on the process history data acquired by the process-history-data acquiring unit 257. In the first embodiment, the use frequency is determined based on the number of processing performed with a setting item set to a setting value different from the default value, but the configuration is not limited thereto.

Suppose the user that has succeeded in login authentication is user-a, and three pieces of the process history data (process history data of the first to the third column) for which the user identification information indicates user-a are acquired.

As for the setting item “color”, the number of times of processing performed with a setting value other than the default value “black and white” is twice. Furthermore, as for the setting item “scaling”, the number of times of processing performed with a setting value other than the default value “100%” is twice. Moreover, as for the setting item “print quantity”, the number of times of processing performed with a setting value other than the default value “1” is 3 times. Furthermore, as for the setting item “density”, the number of times of processing performed with a setting value other than the default value “light” is none. Moreover, as for the setting item “tray”, the number of times of processing performed with a setting value other than the default value “tray 2” is none. Furthermore, as for the setting item “staple”, the number of times of processing performed with a setting value other than the default value “no” is none. Moreover, as for the setting item “punch”, the number of times of processing performed with a setting value other than the default value “no” is none. Furthermore, as for the setting item “sort/stack”, the number of times of processing performed with a setting value other than the default value “no” is none.

Accordingly, in the above example, the use-frequency calculating unit 259 calculates the use frequency of the setting item “color” as 2 times, the use frequency of the setting item “scaling” as 2 times, the use frequency of the setting item “print quantity” as 3 times, the use frequency of the setting item “density” as 0 times, the use frequency of the setting item “tray” as 0 times, the use frequency of the setting item “staple” as 0 times, the use frequency of the setting item “punch” as 0 times, the use frequency of the setting item “sort/stack” as 0 times.

The priority-order determining unit 260 determines the priority of each of one or more setting items based on each of the use frequency of one or more setting items calculated by the use-frequency calculating unit 259, and stores the priority in the priority-order storage unit 261. In the first embodiment, the priority-order determining unit 260 gives a higher priority to a stetting item having the larger number of times in the use frequency, and gives a higher priority, when the numbers of times in the use frequency are the same, to one having a higher priority in the initial state. However, the method of determining a priority is not limited thereto.

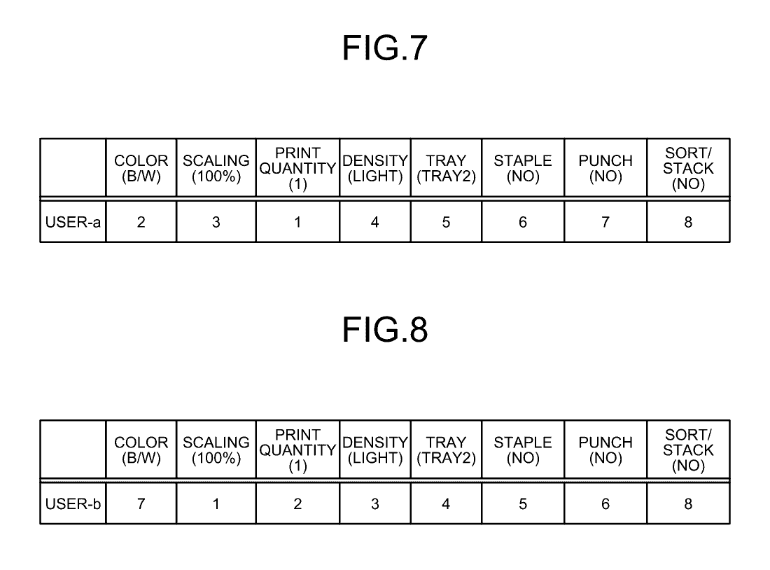

Accordingly, as described above, when the use frequency of the setting item “color” is 2 times, the use frequency of the setting item “scaling” is 2 times, the use frequency of the setting item “print quantity” is 3 times, the use frequency of the setting item “density” is 0 times, the use frequency of the setting item “tray” is 0 times, the use frequency of the setting item “staple” is 0 times, the use frequency of the setting item “punch” is 0 times, and the use frequency of the setting item “sort/stack” is 0 times, the priority order of the respective setting items is in order of “print quantity”, “color”, “scaling”, “density”, “tray”, “staple”, “punch”, and then “sort/stack” as illustrated in FIG. 7.

Moreover, for example, when the user that has succeeded the login authentication is user-b, and two pieces of the process history data (process history data in the fourth to the fifth columns) for which the user identification information indicates user-b are acquired, the priority order of the respective setting items is in the order of “scaling”, “print quantity”, “density”, “tray”, “staple”, “punch”, “color”, and then “sort/stack” as illustrated in FIG. 8.

In the first embodiment, the priority-order storage unit 261 stores not only the priority order of the respective one or more setting items determined by the priority-order determining unit 260, but also the priority order of the respective one or more setting items in the initial state of the image processing apparatus 100. However, the configuration is not limited thereto.

The screen creating unit 263 creates various kinds of screens, and the display control unit 265 displays the screen created by the screen creating unit 263 on the operation panel 205.

For example, the screen creating unit 263 creates a setting screen in which one or more display parts are rearranged based on the use frequency of the respective one or more setting items calculated by the use-frequency calculating unit 259 when the login authentication of a user by the authentication unit 253 results successful, and the display control unit 265 displays the setting screen that is created by the screen creating unit 263 on the operation panel 205.

Specifically, the screen creating unit 263 creates a screen in which one or more display parts are arranged in descending order of the use frequency in accordance with the predetermined arrangement rule as the setting screen in which one or more display parts are rearranged, and the display control unit 265 displays the setting screen created by the screen creating unit 263 on the operation panel 205.

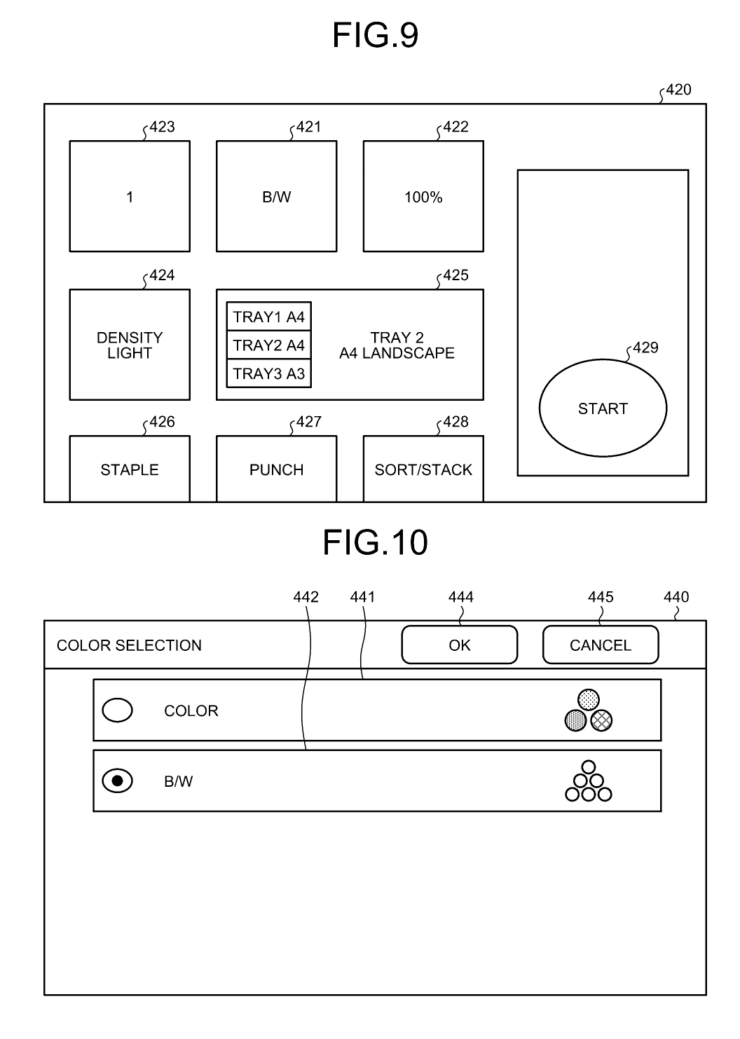

For example, the screen creating unit 263 creates the setting screen 420 as illustrated in FIG. 9 based on the priority order of the respective one or more setting items stored in the priority-order storage unit 261, when login authentication of a user by the authentication unit 253 results successful, and the display control unit 265 displays the setting screen 420 created by the screen creating unit 263 on the operation panel 205.

The setting screen 420 illustrated in FIG. 9 is one in which the display parts 421 to 428 are arranged therein similarly to the setting screen 420 illustrated in FIG. 4; however, the arrangement order is different therefrom. Specifically, in the setting screen 420 illustrated in FIG. 9, the display parts 421 to 428 are arranged in the priority order illustrated in FIG. 7 (the order of “print quantity”, “color”, “scaling”, “density”, “tray”, “staple”, “punch”, and then “sort/stack”).

Accordingly, the display part 423 is arranged at the position 411, the display part 421 is arranged at the position 412, the display part 422 is arranged at the position 413, the display part 424 is arranged at the position 414, the display part 425 is arranged at the positions 415 and 416, the display part 426 is arranged at the position 417, the display part 427 is arranged at the position 418, and the display part 428 is arranged at the position 419.

As described above, in the first embodiment, display parts are arranged in order of priority in the setting screen 420 in accordance with the predetermined arrangement rule, giving a higher priority to one with a higher use frequency. Therefore, a user can grasp the priority order among entire setting items that can be set in the setting screen 420 at a glance, and a setting item with a higher priority can be recommended to the user prior to a setting item with a lower priority.

The arrangement rule described above can be defined in a program to implement the function of the screen creating unit 263, or be stored in the flash memory 204 as arrangement rule data in which the arrangement rule is defined. In the case of storing in the flash memory 204 as the arrangement rule data, the screen creating unit 263 arranges the display parts on a setting screen, referring to the arrangement rule data.

Having created a setting screen, the screen creating unit 263 stores, in the setting-data storage unit 267, each of a setting value of one or more setting items set on the setting screen to manage it.

Furthermore, for example, when a selection input to select a display part is accepted by the accepting unit 251, the screen creating unit 263 creates a user setting screen to let a user make settings to the setting items indicated by the display parts, and the display control unit 265 displays the screen created by the screen creating unit 263 on the operation panel 205.

FIG. 10 illustrates one example of a user setting screen 440 of the first embodiment, and illustrates the user setting screen 440 of the setting item “color” displayed on the operation panel 205 when a selection input to select the display part 421 is accepted by the accepting unit 251.

When a selection input indication selection of a selection key 441 to set to perform copying in color is accepted, and a selection input indicating selection of an OK key 444 is accepted by the accepting unit 251 on the user setting screen 440, the screen creating unit 263 sets “color” to the setting item “color”, and updates the setting of the setting item “color” stored in the setting-data storage unit 267 to “color”, and the display control unit 265 closes the user setting screen 440.

Similarly, when a selection input indicating selection of a selection key 442 to set to perform copying in black and white is accepted, and a selection input indicating selection of the OK key 444 is accepted by the accepting unit 251 on the user setting screen 440, the screen creating unit 263 sets “color” to the setting item “black and white”, and updates the setting of the setting item “color” stored in the setting-data storage unit 267 to “black and white”, and the display control unit 265 closes the user setting screen 440.

Moreover, when a selection input indicating selection of a cancel key 445 is accepted by the accepting unit 251 on the user setting screen 440, the display control unit 265 closes the user setting screen 440.

Although a case in which settings of color are color and monochrome has been explained as an example in the example illustrated in FIG. 10, other color settings, such as bicolor, and monochrome, can be included.

The process requesting unit 269 requests the main unit 300 to perform processing based on the setting of one or more setting items that is set in the setting screen. Thus, the main unit 300 performs processing based on the setting of one or more setting items that is set in the setting screen.

For example, on the setting screen 420 illustrated in FIG. 4, when a selection input indicating selection of a start key 429 is accepted, the process requesting unit 269 acquires a setting of one or more setting items that is set in the setting screen 420 from the setting-data storage unit 267, and requests the main unit 300 for performance of copying based on the acquired setting of one or more setting items. Thus, the main unit 300 performs copying based on the setting of one or more setting items that are set in the setting screen 420.

Furthermore, the process requesting unit 269 creates process history data that indicates a setting of one or more setting items acquired from the setting-data storage unit 267, and stores the process history data in the process-history-data storage unit 255.

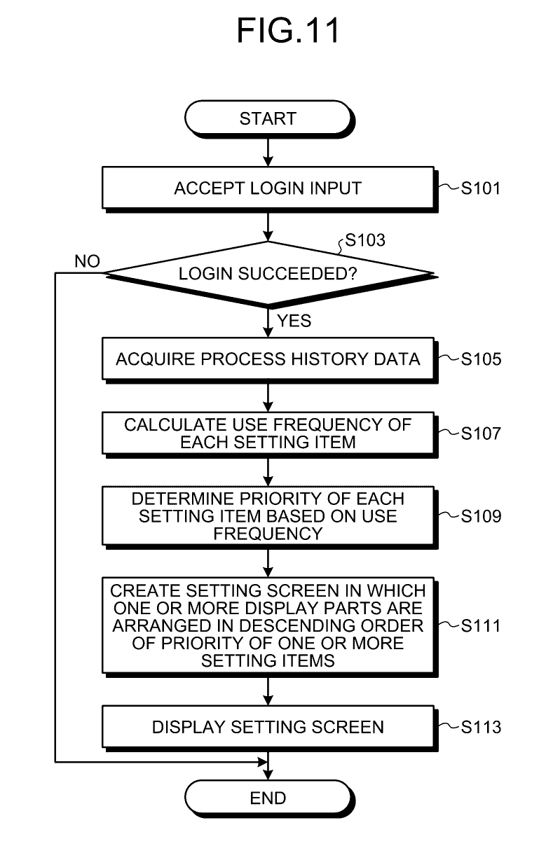

FIG. 11 is a flowchart illustrating one example of display processing performed by the operation unit 200 of the first embodiment.

First, the accepting unit 251 accepts a login input from the operation panel 205 (step S101).

Subsequently, the authentication unit 253 performs login authentication of a user based on the login input accepted by the accepting unit 251 (step S103). When the login authentication resulted failed (step S103: NO), the processing is ended.

On the other hand, when the login authentication resulted successful (step S103: YES), the process-history-data acquiring unit 257 acquires process history data that includes user identification information of the user that has passed the login authentication from the process-history-data storage unit 255 (step S105).

Subsequently, the use-frequency calculating unit 259 calculates a use frequency of each of one or more setting items based on the process history data acquired by the process-history-data acquiring unit 257 (step S107).

Subsequently, the priority-order determining unit 260 determines a priority of each of one or more setting items based on the use frequency of each of one or more setting items calculated by the use-frequency calculating unit 259 (step S109).

Subsequently, the screen creating unit 263 creates a setting screen in which one or more display parts are arranged in descending order of priority of one or more setting items in accordance with a predetermined arrangement rule (step S111).

Subsequently, the display control unit 265 displays the setting screen that is created by the screen creating unit 263 on the operation panel 205 (step S113).

As described above, in the first embodiment, display parts are arranged in order of priority in the setting screen 420 in accordance with the predetermined arrangement rule, giving a higher priority to one with a higher use frequency. Therefore, a user can grasp the priority order among entire setting items that can be set in the setting screen 420 at a glance, and a setting item with a higher priority, that is, a setting item with a higher use frequency can be recommended to the user prior to a setting item with a lower priority, that is, a setting item with a lower use frequency.

Thus, in the first embodiment, a setting item with a high use frequency in past can be recommended to a user in priority, and therefore, a setting item that has a high possibility of being used by a user can be recommended.

Furthermore, display parts that have originally been arranged in a setting screen are rearranged in descending order of priority, not arranging display parts of recommended setting items in the setting screen in addition to the display parts that have originally been arranged in the setting screen. Therefore, it is not necessary to arrange unnecessary display parts in the setting screen, and a setting item having a high possibility of being used by a user can be recommended, suppressing degradation of the visibility of the setting screen.

### (First Modification)

Although the example in which one or more display parts are arranged in descending order of use frequency of a setting item in accordance with the predetermined arrangement rule in the setting screen has been explained in the above first embodiment, in a first modification, an example in which one or more display parts are arranged in order of a display part of a setting item having the use frequency higher than a threshold, and the a display part of a setting item having the use frequency equal to or lower than the threshold, in accordance with a predetermined arrangement rule is explained.

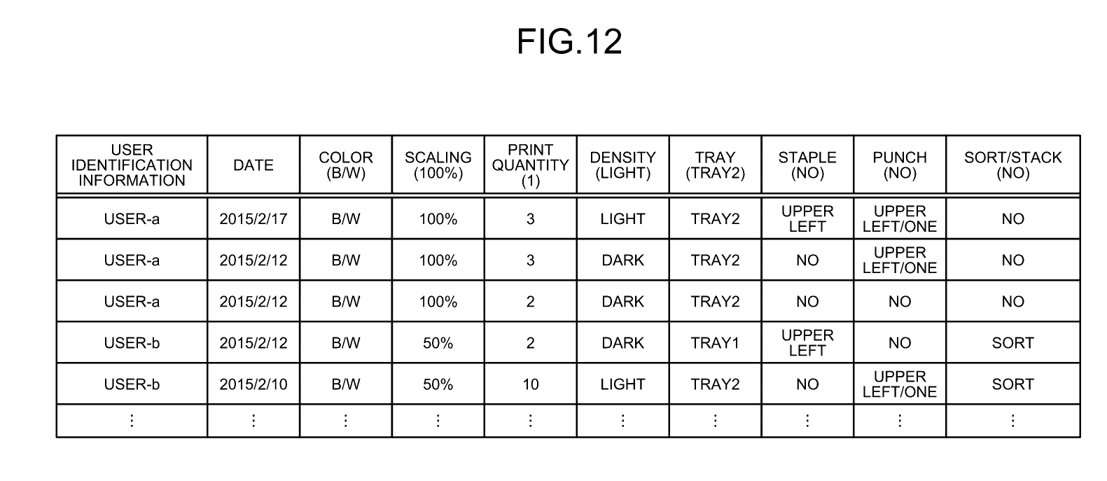

FIG. 12 illustrates one example of process history data that is stored in the process-history-data storage unit 255 of the first modification. Settings of the respective setting items differ from the process history data illustrated in FIG. 6.

For example, suppose the user that has succeeded in login authentication is user-a, and three pieces of the process history data (process history data of the first to the third column) for which the user identification information indicates user-a are acquired from among the process history data illustrated in FIG. 12.

As for the setting item “color”, the number of times of processing performed with a setting value other than the default value “black and white” is none. Furthermore, as for the setting item “scaling”, the number of times of processing performed with a setting value other than the default value “100%” is none. Moreover, as for the setting item “print quantity”, the number of times of processing performed with a setting value other than the default value “1” is three times. Furthermore, as for the setting item “density”, the number of times of processing performed with a setting value other than the default value “light” is twice. Moreover, as for the setting item “tray”, the number of times of processing performed with a setting value other than the default value “tray 2” is none. Furthermore, as for the setting item “staple”, the number of times of processing performed with a setting value other than the default value “no” is once. Moreover, as for the setting item “punch”, the number of times of processing performed with a setting value other than the default value “no” is twice. Furthermore, as for the setting item “sort/stack”, the number of times of processing performed with a setting value other than the default value “no” is none.

Accordingly, in the above example, the use-frequency calculating unit 259 calculates the use frequency of the setting item “color” as 0 times, the use frequency of the setting item “scaling” as 0 times, the use frequency of the setting item “print quantity” as 3 times, the use frequency of the setting item “density” as 2 times, the use frequency of the setting item “tray” as 0 times, the use frequency of the setting item “staple” as 1 time, the use frequency of the setting item “punch” as 2 times, the use frequency of the setting item “sort/stack” as 0 times.

In the first modification, the priority-order determining unit 260 gives higher priority to a setting item having the number of times in the use frequency that exceeds a threshold than a setting item having the number of times in the use frequency that is equal to or lower than the threshold. Among setting items having the number of times in the use frequency that is equal to or lower than the threshold, the priority-order determining unit 260 gives higher priority to one having a higher priority in the initial state, and among setting items having the number of times in the use frequency that exceeds the threshold, gives a higher priority to one having a higher priority in the initial state.

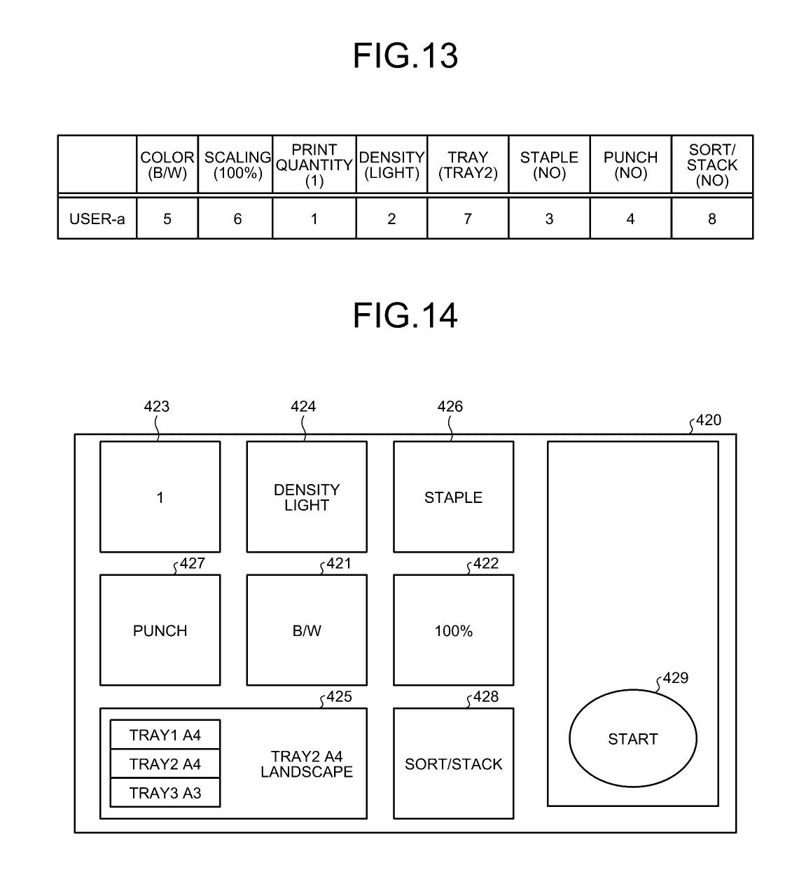

Suppose that the threshold is 0, and as described above, the use frequency of the setting item “color” is 0 times, the use frequency of the setting item “scaling” is 0 times, the use frequency of the setting item “print quantity” is 3 times, the use frequency of the setting item “density” is 2 times, the use frequency of the setting item “tray” is 0 times, the use frequency of the setting item “staple” is 1 time, the use frequency of the setting item “punch” is 2 times, and the use frequency of the setting item “sort/stack” is 0 times. In this case, the priority order of the respective setting items is order of “print quantity”, “density”, “staple”, “punch”, “color”, “scaling”, “tray”, and then “sort/stack” as illustrated in FIG. 13. Note that the threshold is not limited to 0, but can be set to any value.

In the first modification, the screen creating unit 263 creates a screen in which one or more display parts are arranged in order of a display part of a setting item having the use frequency that exceeds the threshold, and then a display part of a setting item having the use frequency that is equal to or lower than the threshold as a setting screen in which the one or more display parts are rearranged, and the display control unit 265 displays the setting screen created by the screen creating unit 263 on the operation panel 205.

For example, when login authentication of a user results successful, the screen creating unit 263 creates the setting screen 420 as illustrated in FIG. 14 based on the priority order of the respective one or more setting items that is stored in the priority-order storage unit 261, and the display control unit 265 displays the setting screen 420 created by the screen creating unit 263 on the operation panel 205.

The setting screen 420 illustrated in FIG. 14 is a screen in which the display parts 421 to 428 are arranged therein similarly to the setting screen 420 illustrated in FIG. 4, but the arrangement order is different. Specifically, in the setting screen 420 illustrated in FIG. 14, the display parts 421 to 428 are arranged in order or priority illustrated in FIG. 13 (order of “print quantity”, “density”, “staple”, “punch”, “color”, “scaling”, “tray”, and then “sort/stack”).

Accordingly, the display part 423 is arranged at the position 411, the display part 424 is arranged at the position 412, the display part 426 is arranged at the position 413, the display part 427 is arranged at the position 414, the display part 421 is arranged at the position 415, the display part 422 is arranged at the position 416, the display part 425 is arranged at the positions 417 and 418, and the display part 428 is arranged at the position 419.

As described above, in the first modification, display parts are arranged in order of priority in the setting screen 420 in accordance with the predetermined arrangement rule, giving a higher priority to one with a use frequency that exceeds a threshold. Therefore, a user can grasp the priority order among entire setting items that can be set in the setting screen 420 at a glance, and a setting item with a higher priority, that is, a setting item with a use frequency that exceeds the threshold can be recommended to the user prior to a setting item with a lower priority, that is, a setting item with a use frequency that is equal to or lower than the threshold.

Thus, in the first modification, a setting item with a past use frequency that exceeds a threshold can be recommended to a user in priority, and therefore, a setting item that has a high possibility of being used by a user can be recommended.

Moreover, in the first modification, display parts that have originally been arranged in a setting screen are rearranged in order of a display part of a setting item having the use frequency that exceeds a threshold, and then a display part of a setting item having the use frequency that is equal to or lower than the threshold, not arranging display parts of setting items recommended to a user in the setting screen in addition to the display parts that have originally been arranged in the setting screen. Therefore, it is not necessary to arrange unnecessary display parts in the setting screen, and a setting item having a high possibility of being used by a user can be recommended, suppressing degradation of the visibility of the setting screen.

### (Second Modification)

In the above first modification, the example in which one or more display parts are arranged in order of a display part of a setting item having the use frequency that exceeds a threshold, and then a display part of a setting item having the use frequency that is equal to or lower than the threshold in accordance with a predetermined arrangement rule has been explained. In a second modification, an example in which a display part of a setting item with the use frequency that exceeds a threshold out of one or more display parts are arranged in accordance with a predetermined arrangement rule in a setting screen is explained.

In the second modification, the priority-order determining unit 260 excludes a setting item with the use frequency that is equal to or lower than a threshold, and gives a higher priority to a setting item having a higher priority in the initial state among setting items with the number of times in the use frequency that exceeds the threshold.

Suppose that the threshold is 0, and the use frequency of the setting item “color” is 0 times, the use frequency of the setting item “scaling” is 0 times, the use frequency of the setting item “print quantity” is 3 times, the use frequency of the setting item “density” is 2 times, the use frequency of the setting item “tray” is 0 times, the use frequency of the setting item “staple” is 1 time, the use frequency of the setting item “punch” is 2 times, and the use frequency of the setting item “sort/stack” is 0 times. In this case, the priority order of the respective setting items is order of “print quantity”, “density”, “staple”, and then “punch”, and “color”, “scaling”, “tray”, and “sort/stack” are excluded from the subject of prioritization.

In the second modification, the screen creating unit 263 creates a screen in which a display part of a setting item with the use frequency that exceeds the threshold out of one or more display parts are arranged in accordance with the predetermined arrangement rule as a setting screen in which one or more display parts are rearranged, and the display control unit 265 displays the setting screen created by the screen creating unit 263 on the operation panel 205.

For example, when a user passes the login authentication by the authentication unit 253, the screen creating unit 263 creates the setting screen 420 as illustrated in FIG. 16 based on the priority order of the respective one or more setting items stored in the priority-order storage unit 261, and the display control unit 265 displays the setting screen 420 created by the screen creating unit 263 on the operation panel 205.

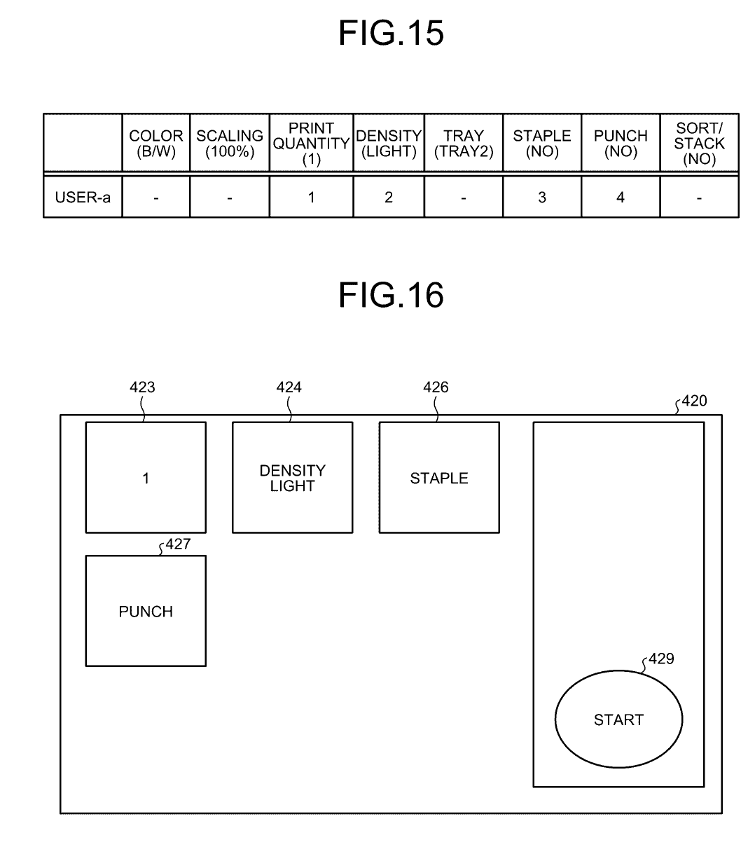

In the setting screen 240 illustrated in FIG. 16, the display parts 423, 424, 426, and 427 are arranged in the priority order illustrated in FIG. 15 (the order of “print quantity”, “density”, “staple”, and then “punch”). Accordingly, the display part 423 is arranged at the position 411, the display part 424 is arranged at the position 412, the display part 426 is arranged at the position 413, and the display part 427 is arranged at the position 414.

As described above, in the second modification, a display part of a setting item with the use frequency that exceeds a threshold is arranged in the setting screen 420 without arranging a display part of a setting item with the use frequency that is equal to or lower than the threshold in the setting screen 420. Therefore, a setting item with the use frequency that exceeds the threshold can be recommended to a user in priority.

Thus, in the second modification, not arranging display parts of setting items recommended to a user in a setting screen in addition to the display parts that have originally been arranged in the setting screen, a display part of a setting item with the past use frequency that exceeds a threshold is arranged, out of display parts that have originally been arranged in a setting screen. Therefore, it is not necessary to arrange unnecessary display parts in the setting screen, and a setting item having a high possibility of being used by a user can be recommended, suppressing degradation of the visibility of the setting screen.

### (Third Modification)

In the second modification, the example in which a display part of a setting item with the use frequency that exceeds a threshold out of one or more display parts are arranged in a setting screen in accordance with a predetermined arrangement rule has been explained. In a third embodiment, an example of arrangement in descending order of use frequency of setting items is further explained.

In the third modification, the priority-order determining unit 260 excludes a setting item having the number of times in the use frequency that is equal to or lower than a threshold from a subject of prioritization, and among setting items having the number of times in the use frequency that exceeds the threshold, gives higher priority to a setting item having the larger number of times in the use frequency, and when the number of times in the use frequency is the same, gives a higher priority to one having a higher priority in the initial state.

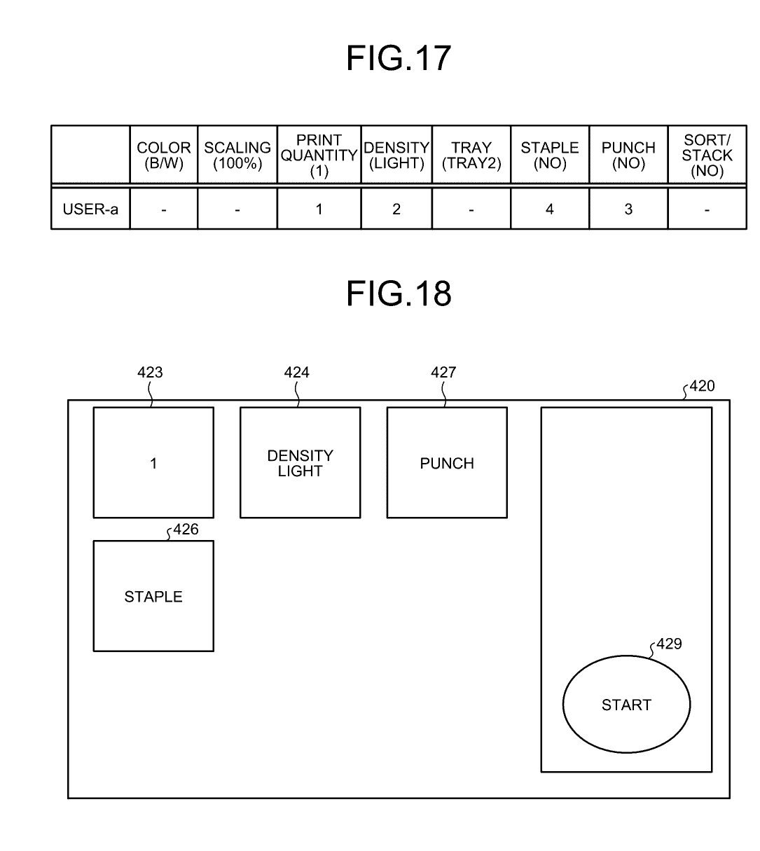

Suppose that the threshold is 0, and as explained in the first modification, the use frequency of the setting item “color” is 0 times, the use frequency of the setting item “scaling” is 0 times, the use frequency of the setting item “print quantity” is 3 times, the use frequency of the setting item “density” is 2 times, the use frequency of the setting item “tray” is 0 times, the use frequency of the setting item “staple” is 1 time, the use frequency of the setting item “punch” is 2 times, and the use frequency of the setting item “sort/stack” is 0 times. In this case, the priority order of the respective setting items is order of “print quantity”, “density”, “punch”, and then “staple” as illustrated in FIG. 17, and “color”, “scaling”, “tray”, and “sort/stack” are excluded from the subject of prioritization.

In the third modification, the screen creating unit 263 creates a screen in which display parts of setting items with the use frequency that exceeds the threshold out of one or more display parts are arranged in descending order of use frequency of a setting item in accordance with the predetermined arrangement rule as a setting screen in which one or more display parts are rearranged, and the display control unit 265 displays the setting screen created by the screen creating unit 263 on the operation panel 205.

For example, when a user passes the login authentication by the authentication unit 253, the screen creating unit 263 creates the setting screen 420 as illustrated in FIG. 18 based on the priority order of the respective one or more setting items stored in the priority-order storage unit 261, and the display control unit 265 displays the setting screen 420 created by the screen creating unit 263 on the operation panel 205.

In the setting screen 240 illustrated in FIG. 18, the display parts 423, 424, 427, and 426 are arranged in the priority order illustrated in FIG. 17 (the order of “print quantity”, “density”, “punch”, and then “staple”). Accordingly, the display part 423 is arranged at the position 411, the display part 424 is arranged at the position 412, the display part 427 is arranged at the position 413, and the display part 426 is arranged at the position 414.

As described above, in the third modification, a display part of a setting item with the use frequency that exceeds the threshold is arranged in order of use frequency of a setting item in the setting screen 420 without arranging a display part of a setting item with the use frequency that is equal to or lower than the threshold in the setting screen 420. Therefore, a setting item with the use frequency that exceeds the threshold can be recommended to a user in priority.

Thus, in the third modification, setting items having a past use frequency that exceeds the threshold can be recommended to a user in descending or der of use frequency in priority, and therefore, a setting item having a high possibility of being used by the user can be recommended.

Moreover, in the third modification, not arranging display parts of setting items recommended to a user in a setting screen in addition to the display parts that have originally been arranged in the setting screen, display parts of setting items with the past use frequency that exceeds a threshold are arranged in descending order of use frequency, out of display parts that have originally been arranged in the setting screen. Therefore, it is not necessary to arrange unnecessary display parts in the setting screen, and a setting item having a high possibility of being used by a user can be recommended, suppressing degradation of the visibility of the setting screen.

### (Fourth Modification)

In the second modification, the example in which a display part of a setting item with the use frequency that exceeds a threshold out of one or more display parts are arranged in a setting screen in accordance with a predetermined arrangement rule has been explained. In a fourth embodiment, an example in which a display part that is selected by a user from among display parts of a setting item with the use frequency that is equal to or lower than a threshold is further arranged in a setting screen is explained.

The accepting unit 251 accepts, from the operation panel 205, a display instruction input to instruct display of a selection screen to select a display part of a setting item with the use frequency that is equal to or lower than a threshold from among one or more display parts.

When the display instruction input is accepted by the accepting unit 251, the screen creating unit 263 creates a selection screen, and the display control unit 265 displays the screen created by the screen creating unit 263 on the operation panel 205.

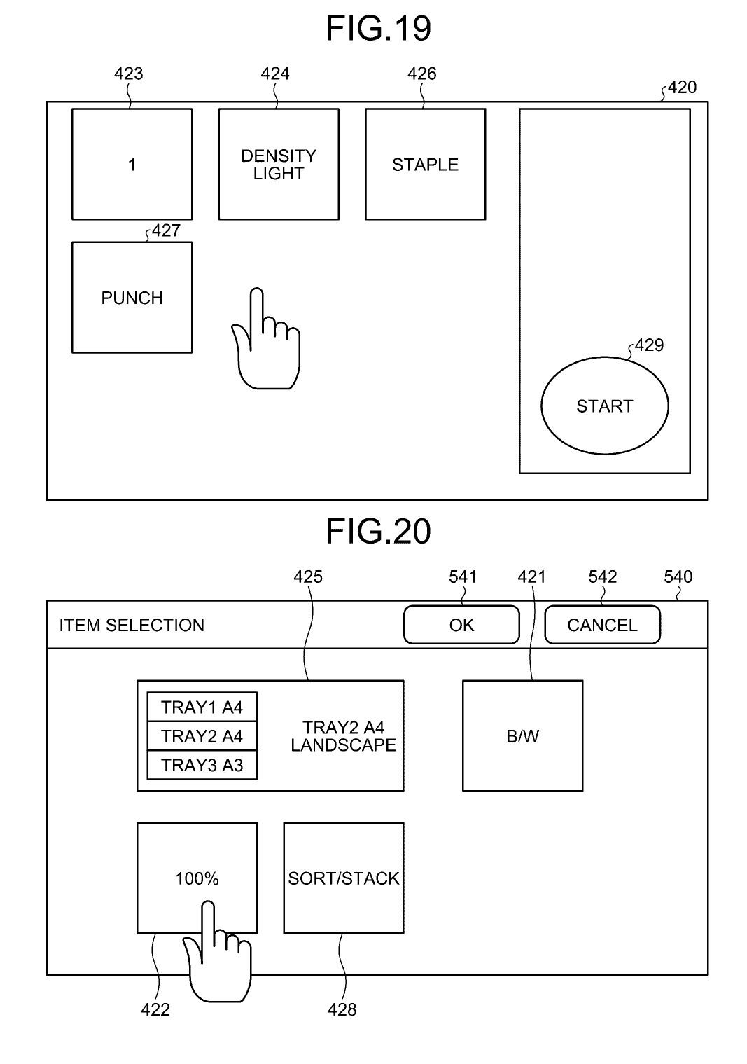

For example, as illustrated in FIG. 19, an input of selecting a position to which a display part is added is accepted by the accepting unit 251 as the display instruction input in the setting screen 420, the screen creating unit 263 creates a selection screen as illustrated in FIG. 20, and the display control unit 265 displays the screen created by the screen creating unit 263 on the operation panel 205.

FIG. 20 illustrates one example of a selection screen 540 of the fourth modification, and illustrates the selection screen 540 when setting items having the use frequency that is equal to or lower than a threshold are “color”, “scaling”, “tray”, and “sort/stack”.

The accepting unit 251 accepts, from the operation panel 205, a selection input to select either one of the display parts of a setting item with the use frequency that is equal to or lower than the threshold on the selection screen.

For example, on the selection screen 540, when a selection input to select either one of the display part 425, the display part 421, the display part 422, and the display part 428, and a selection input to select an OK key 541 is accepted by the accepting unit 251, the display control unit 265 closes the selection screen 540. The screen creating unit 263 creates a screen in which a display part of a setting item with the use frequency that exceeds the threshold out of one or more display parts, and a display part for which the selection input is accepted are arranged in this order in accordance with a predetermined arrangement rule, as a setting screen in which one or more display parts are rearranged, and the display control unit 265 displays the setting screen created by the screen creating unit 263 on the operation panel 205.

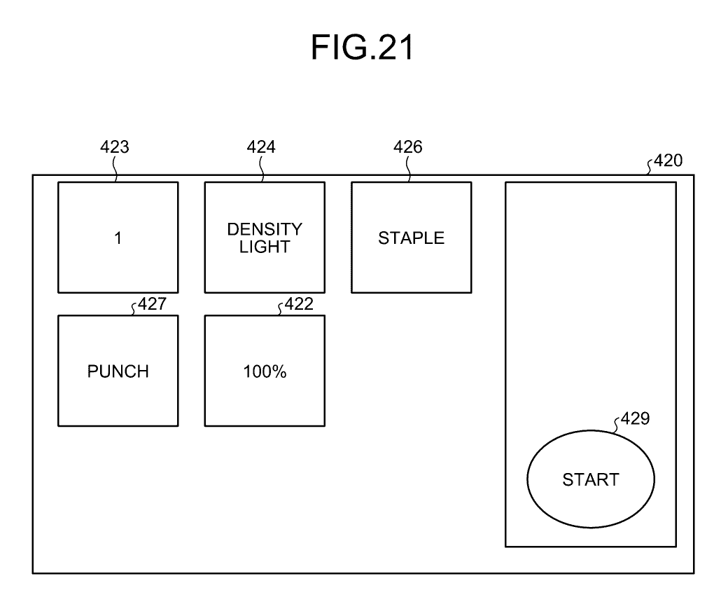

For example, when the display part 422 is selected on the selection screen 540 by the accepting unit 251, the screen creating unit 263 creates the setting screen 420 as illustrated in FIG. 21, and the display control unit 265 displays the setting screen 420 created by the screen creating unit 263 on the operation panel 205.

In the setting screen 240 illustrated in FIG. 21, the display parts 423, 424, 426, and 427 are arranged in the priority order illustrated in FIG. 15 (the order of “print quantity”, “density”, “staple”, and then “punch”), and the display part 422 that is selected on the selection screen 540 is arranged in addition thereto. Accordingly, the display part 423 is arranged at the position 411, the display part 424 is arranged at the position 412, the display part 426 is arranged at the position 413, the display part 427 is arranged at the position 414, and the display part 422 is arranged at the position 415.

When a selection input to select a cancel key 542 is accepted by the accepting unit 251 on the selection screen 540, the display control unit 265 closes the selection screen 540.

As described above, according to the fourth modification, a display part of a setting item with the use frequency that is equal to or lower than a threshold that has not been arranged in the setting screen 420 can be rearranged in the setting screen 420.

Although modification to the second modification has been explained as an example in the fourth modification, the same modification can be made also to the third modification.

### (Fifth Modification)

In the first embodiment and the modifications described above, the example in which the use frequency of a setting item is calculated using process history data by the image processing apparatus alone. In a fifth modification, an example in which the use frequency of a setting item is calculated using process history data by plural units of the image processing apparatus 100 is explained.

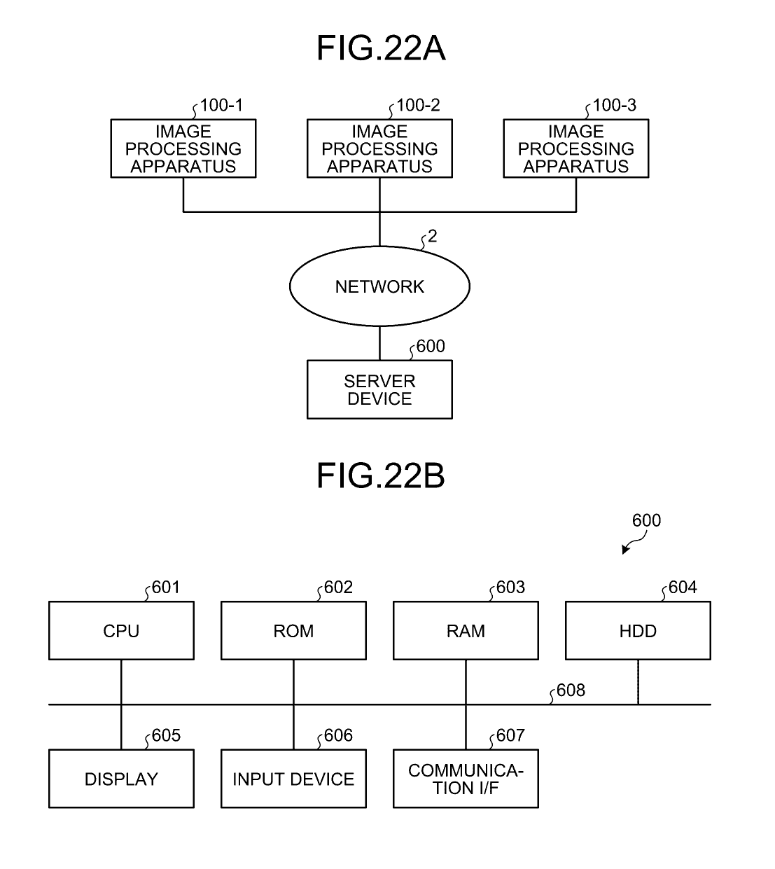

FIG. 22A is a schematic diagram illustrating one example of a configuration of a system of the fifth modification. As illustrated in FIG. 22A, the system of the fifth modification includes image processing apparatuses 100-1 to 100-3, and a server device 600. The image processing apparatuses 100-1 to 100-3 and the server device 600 are connected through a network 2. The network 2 can be, for example, a local area network (LAN), the Internet, and the like. Although a case in which the number of units of the image processing apparatuses provided is three is explained in the fifth modification, the number is not limited thereto, and the number may be any number as long as the number is more than one.

The image processing apparatuses 100-1 to 100-3 have the same configuration as the image processing apparatus 100 explained in the first embodiment and the modifications described above except the point in that the process-history-data storage unit 255 is not provided.

The server device 600 is a general computer. FIG. 22B is a schematic diagram illustrating one example of a hardware configuration of the server device 600 of the fifth modification. As illustrated in FIG. 22B, the server device 600 includes a CPU 601, a ROM 602, a RAM 603, an HDD 604, a display 605, an input device 606, and a communication I/F 607. The CPU 601, the ROM 602, the RAM 603, the HDD 604, the display 605, the input device 606, and the communication I/F 607 are connected to each other through a system bus 608.

The CPU 601 controls overall operation of the server device 600. The CPU 601 executes a program that is stored in the ROM 602, the HDD 604, or the like using the RAM 603 as a work area, thereby controlling overall operation of the server device 600.

The communication I/F 607 is an interface to communicate with an external device through a network. The display 605 displays various kinds of images (screens). The input device 606 makes various kinds of inputs according to an operation by a user. The display 605 and the input device 606 can be unified as a touch panel or the like, not configured separately.

The server device 600 includes the process-history-data storage unit 255 that is explained in the first embodiment and the modifications described above. That is, in the fifth modification, the process requesting unit 269 of the respective image processing apparatuses 100-1 to 100-3 stores generated process history data in the process-history-data storage unit 255 included in the server device 600.

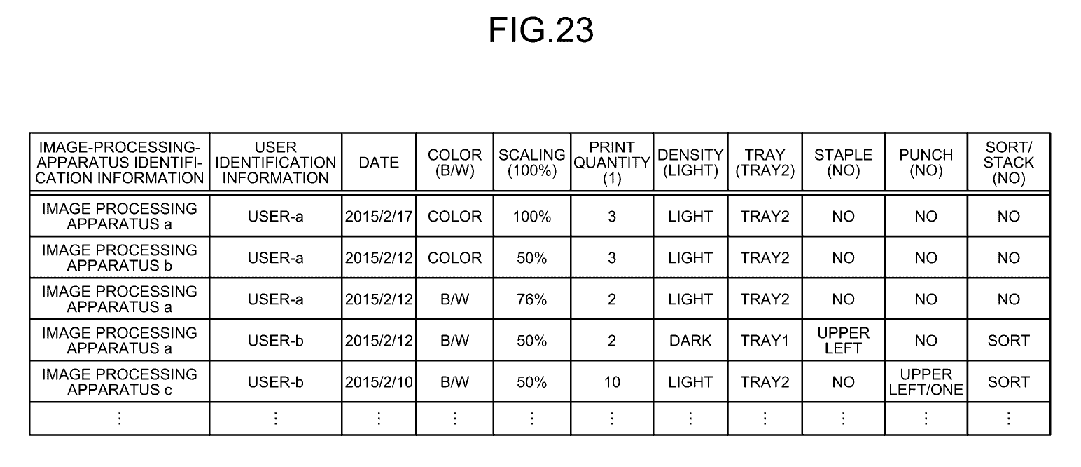

FIG. 23 illustrates one example of process history data that is stored in the process-history-data storage unit 255 of the fifth modification. The process history data illustrated in FIG. 23 illustrates image-processing-apparatus identification information in addition to elements included in the process history data illustrated in FIG. 6. The image-processing-apparatus identification information is an identifier to identify an image processing apparatus that has performed processing indicated by the process history data, and is, for example, an ID or a serial number of the image processing apparatus, but is not limited thereto.

Moreover, the process-history-data acquiring unit 257 of the image processing apparatuses 100-1 to 100-3 respectively acquires process history data from the process-history-data storage unit 255 included in the server device 600. That is, the process-history-data acquiring unit 257 of the image processing apparatuses 100-1 to 100-3 acquires not only process history data of the own image processing apparatus 100, but also process history data of at least one of the other image processing apparatuses 100. An acquiring rule for process history data can be the same as of the first embodiment.

Furthermore, the use-frequency calculating unit 259 of the image processing apparatuses 100-1 to 100-3 respectively calculates a use frequency of one or more setting items based on the process history data acquired by the process-history-data acquiring unit 257.

As described above, according to the fifth modification, the use frequency of a setting item can be calculated based on process history data in more than one image processing apparatus to determine the priority order.

### Second Embodiment

In a second embodiment, an example in which arrangement order of display parts are determined considering a condition of an image processing apparatus in addition to use frequencies of setting items is explained. In the following, a point different from the first embodiment is mainly explained, and as for components having the same functions as of the first embodiment, names and symbols identical to the first embodiment are assigned thereto, and the explanation thereof is omitted.

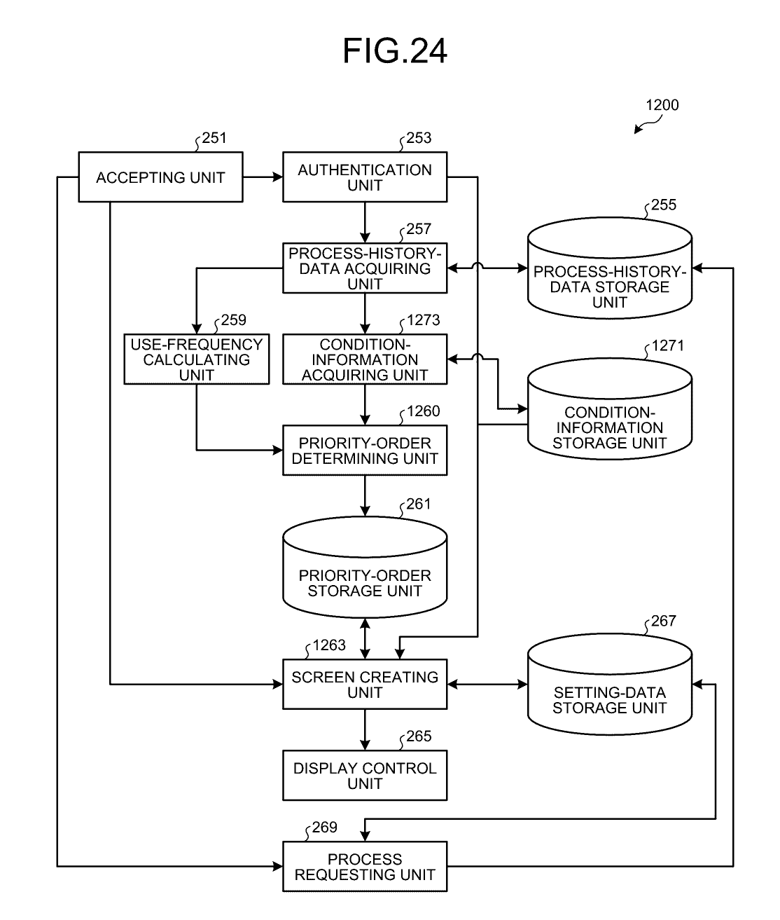

FIG. 24 is a block diagram illustrating one example of a functional configuration of an operation unit 1200 of the second embodiment. As illustrated in FIG. 24, in the second embodiment, a condition-information storage unit 1271, a condition-information acquiring unit 1273, a priority-order determining unit 1260, and a screen creating unit 1263 of the operation unit 1200 are different from the first embodiment.

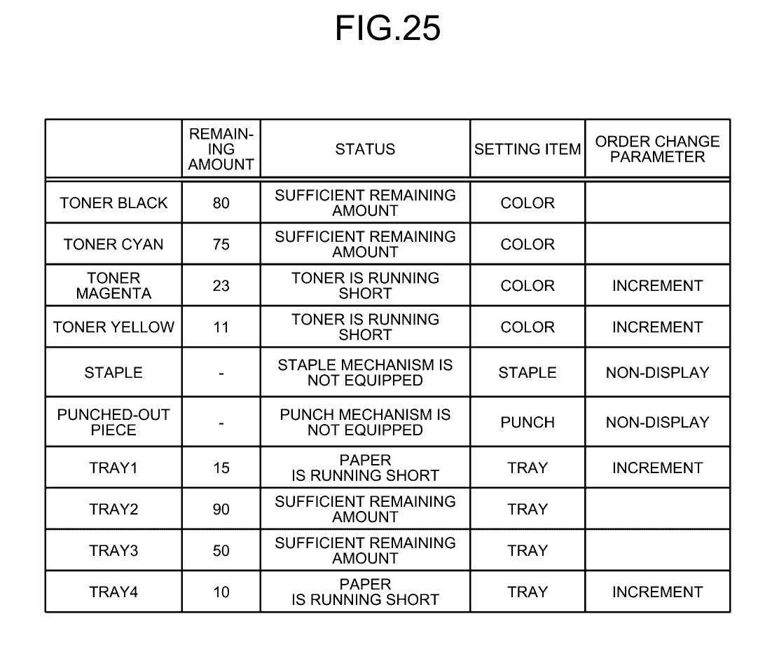

The condition-information storage unit 1271 stores condition information relating to a condition of the image processing apparatus 100 including the operation unit 1200. FIG. 25 illustrates one example of condition information that is stored in the condition-information storage unit 1271 of the second embodiment. In the example illustrated in FIG. 25, the condition information indicates a remaining amount, a status (condition), a setting item, and an order change parameter per mechanism relating to the image processing apparatus 100.

The mechanism relating to the image processing apparatus 100 includes, as illustrated in FIG. 25, toner, tray, and optional components (staple, or punched-out piece), and the like, but not limited thereto. The punched-out piece signifies a storage unit to store punched-out paper pieces.

The remaining amount indicates a remaining amount relating to the mechanism of the image processing apparatus 100. The remaining amount may be a toner remaining amount for toner, and a paper remaining amount stored in a tray, for tray. As for the optional component, if the image processing apparatus 100 has no optional component, the remaining amount is not set.

The status indicates a state of the image processing apparatus 100 that is derived from the remaining amount of the mechanism relating to the image processing apparatus 100. As for the optional component, if the image processing apparatus 100 has no optional component, that fact is set.

The setting item indicates a setting item relating to the mechanism of the image processing apparatus 100. The setting item may be the setting item “color” for toner, the setting item “staple” for staple, “the setting item “punch” for punched-out piece, and the setting item “tray” for tray.

The order change parameter is a parameter that is used for changing the priority order of a setting item. Although in the second embodiment, an increment parameter to increment (add) the priority when a remaining amount becomes small (being equal to or smaller than a predetermined threshold for a remaining amount) is set, the configuration is not limited thereto. Moreover, although in the second embodiment, an example in which the increment parameter is a parameter to increment a priority to be highest is explained, the increment parameter is not limited thereto, but can be a parameter that is determined how higher a priority is to be incremented. As for the optional component, if the image processing apparatus 100 has no optional component, the optional component is set to be out of a subject (non-display) of prioritization.

The condition-information acquiring unit 1273 acquires condition information from the condition-information storage unit 1271.

The priority-order determining unit 1260 determines a priority of each of one or more setting items based on the use frequency of each of one or more setting items calculated by the use-frequency calculating unit 259 and the condition information acquired by the condition-information acquiring unit 1273.

Although in the second embodiment, an example in which the priority-order determining unit 1260 determines the priority of each of the one or more setting items tentatively based on the use frequency, and then determines the priority of each of one or more setting items based on the condition information formally is explained, the configuration is not limited thereto.

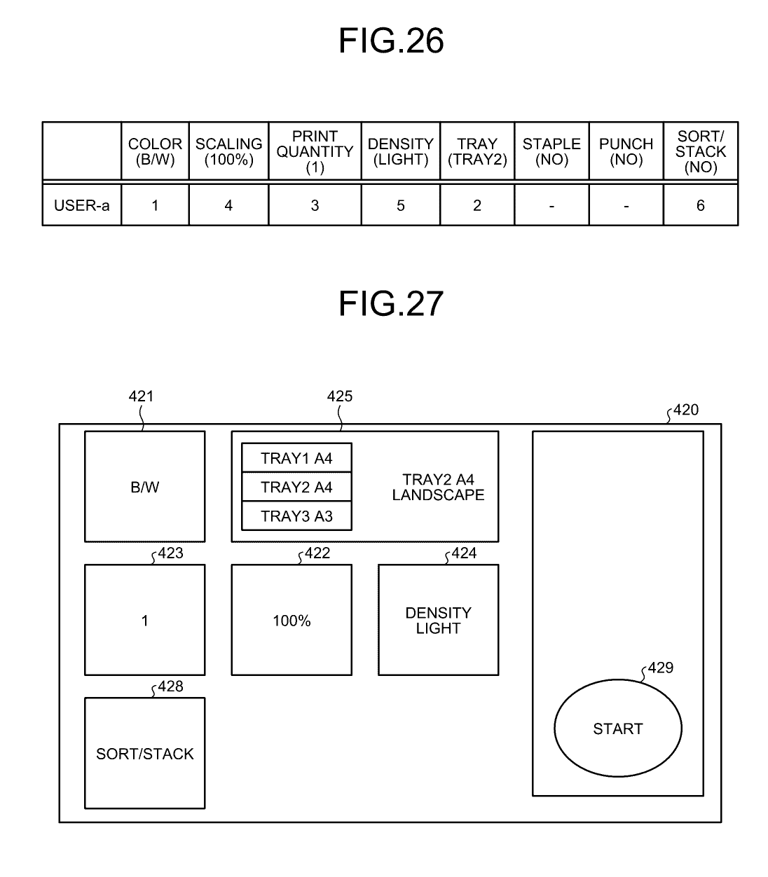

For example, the priority order of setting items tentatively determined based on the use frequency is the priority order illustrated in FIG. 8. In this case, based on the condition information illustrated in FIG. 25, as the increment parameter is set to the setting item “color” and the setting item “tray”, the priority-order determining unit 1260 gives the highest priority to “color”, and gives the second highest priority to “tray”. The reason why the priority of “color” is higher than “tray” is because the priority of “color” is higher than “tray” in the initial state. Moreover, based on the condition information illustrated in FIG. 25, as non-display is set to the setting item “staple” and the setting item “punch”, the priority-order determining unit 1260 excludes “staple” and “punch” from a subject of prioritization. As for the setting items that are not mentioned in the condition information, the priority-order determining unit 1260 re-assigns priorities thereto in descending order of the original priority order. Specifically, the priority-order determining unit 1260 gives the third highest priority to the setting item “print quantity”, the original priority of which is the first highest, gives the fourth highest priority to the setting item “scaling”, the original priority of which is the third highest, gives the fifth highest priority to the setting item “density”, the original priority of which is the fourth highest, and gives the sixth highest priority to the setting item “sort/stack”, the original priority of which is the eighth highest. As a result, the priority order or the respective setting items is order of “color”, “tray”, “print quantity”, “scaling”, “density”, and then “sort/stack” as illustrated in FIG. 26.

The screen creating unit 1263 creates a setting screen in which one or more display parts are rearranged based on the use frequency of each of one or more setting items calculated by the use-frequency calculating unit 259, and the condition information acquired by the condition-information acquiring unit 1273. The display control unit 265 displays the setting screen created by the screen creating unit 1263 on the operation panel 205.

For example, the screen creating unit 1263 creates the setting screen 420 as illustrated in FIG. 27, and the display control unit 265 displays the setting screen 420 created by the screen creating unit 1263 on the operation panel 205. In the setting screen 420 illustrated in FIG. 27, the display parts 421 to 425, and 428 are arranged in the priority order illustrated in FIG. 26 (order of “color”, “tray”, “print quantity”, “scaling”, “density”, and then “sort/stack”).

Accordingly, the display part 421 is arranged at the position 411, the display part 425 is arranged at the positions 412 and 413, the display part 423 is arranged at the position 414, the display part 422 is arranged at the position 415, the display part 424 is arranged at the position 416, and the display part 428 is arranged at the position 417.

Furthermore, when a selection input to select a display part is accepted by the accepting unit 251, the screen creating unit 1263 creates a user setting screen to let a user make a setting to the setting item indicated by the display part, and the display control unit 265 displays the screen created by the screen creating unit 1263 on the operation panel 205. The screen creating unit 1263 changes arrangement order of selection keys in the user setting screen based on the condition information.

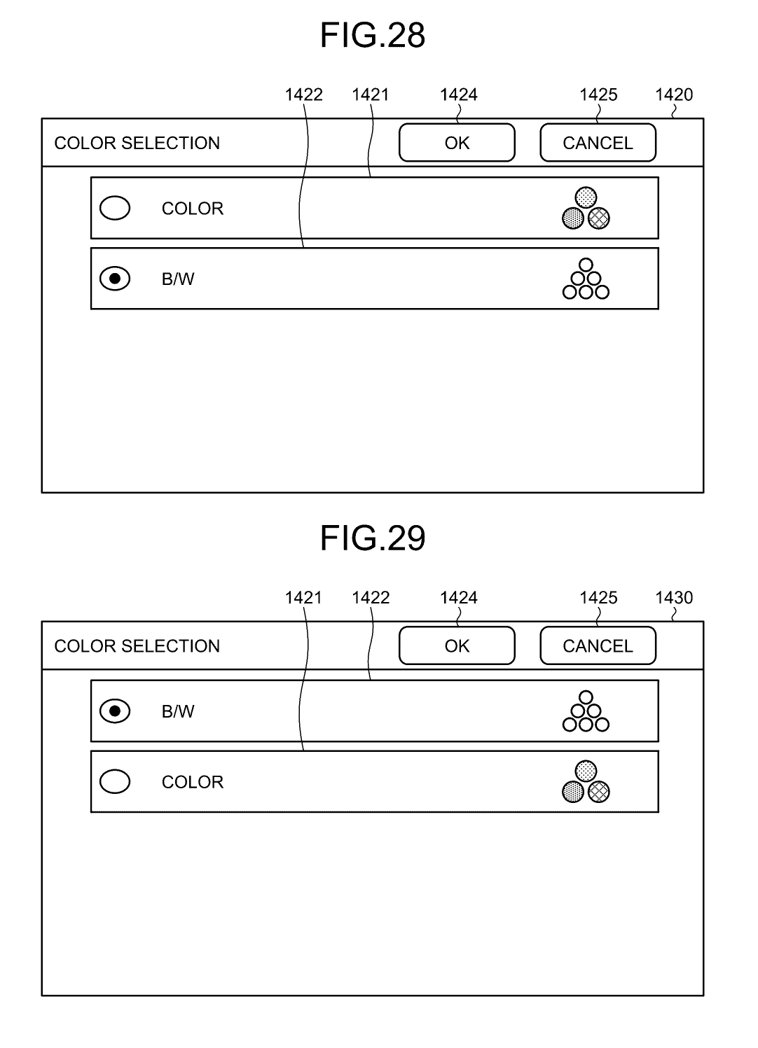

FIG. 28 illustrates one example of a user setting screen 1420 of the second embodiment, and illustrates the user setting screen 1420 when any of statuses of toners is “sufficient remaining amount”. In this case, the screen creating unit 1263 arranges selection keys in order of a selection key 1421 to set to perform copying in color, and then a selection key 1422 to set to perform copying in black and white as illustrated in FIG. 28.

On the other hand, FIG. 29 illustrates one example of a user setting screen 1430 of the second embodiment, and illustrates the user setting screen 1430 when either one of statuses of toners in the condition information is “toner is out”. In this case, there is a possibility that color copying is disabled due to shortage of toner, and therefore, the screen creating unit 1263 arranges the selection keys in order of the selection key 1422 to set to perform copying in black and white, and then the selection key 1421 to set to perform copying in color as illustrated in FIG. 29.

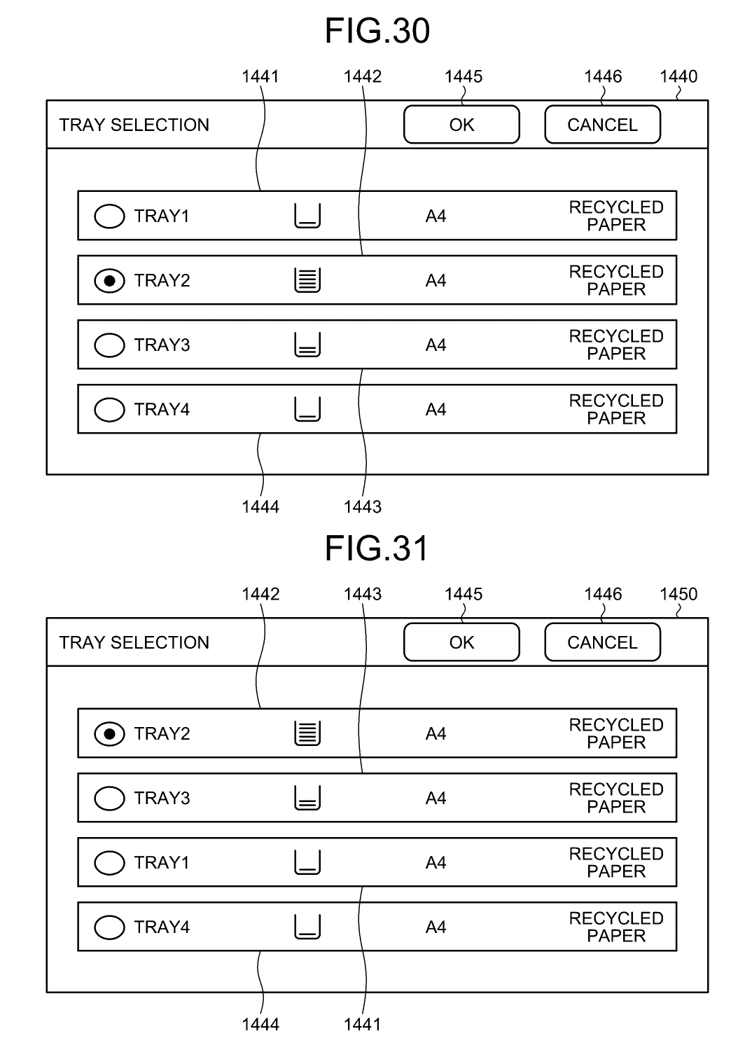

FIG. 31 illustrates one example of a user setting screen 1450 of the second embodiment, and illustrates the user setting screen 1450 when status of tray 1 and tray 4 are “paper is low” in the condition information. In this case, there is a possibility that copying is disabled due to shortage of paper, and therefore, the screen creating unit 1263 arranges the selection keys in order of a selection key 1442 to set to tray 2 that has a sufficient remaining amount of paper, a selection key 1443 to set to tray 3 that has a sufficient remaining amount of paper, a selection key 1441 to set to tray 1 with a low remaining amount of paper, and then z selection key 1444 to set to tray 4 with a low remaining amount of paper as illustrated in FIG. 30.

FIG. 30 illustrates a comparison example of FIG. 31, and illustrates the user setting screen 1440 in which selection keys are arranged without considering the condition information. In the example illustrated in FIG. 30, even though the statuses of tray 1 and tray 4 in the condition information are “paper is low”, the selection keys are arranged in order of the selection key 1441 to set to tray 1 with a low remaining amount of paper, the selection key 1442 to set to tray 2 with a sufficient remaining amount of paper, the selection key 1443 to set to tray 3 with a sufficient remaining amount of paper, and then the selection key 1444 to set to tray 4 with a low remaining amount of paper.

FIG. 33 illustrates one example of a user setting screen 1470 of the second embodiment, and illustrates the user setting screen 1470 when statuses of tray 1 and tray 4 are “paper is out”. In this case, because copying cannot be done with tray 1 and tray 4 due to shortage of paper, the screen creating unit 1263 arranges selection keys in order of a selection key 1462 to set to tray 2 that has a sufficient remaining amount of paper, and then a selection key 1463 to set to tray 3 that has a sufficient remaining amount of paper, and does not arrange a selection key to set to tray 1 that has not remaining amount of paper and a selection key to set to tray 4 that has no remaining amount of paper.

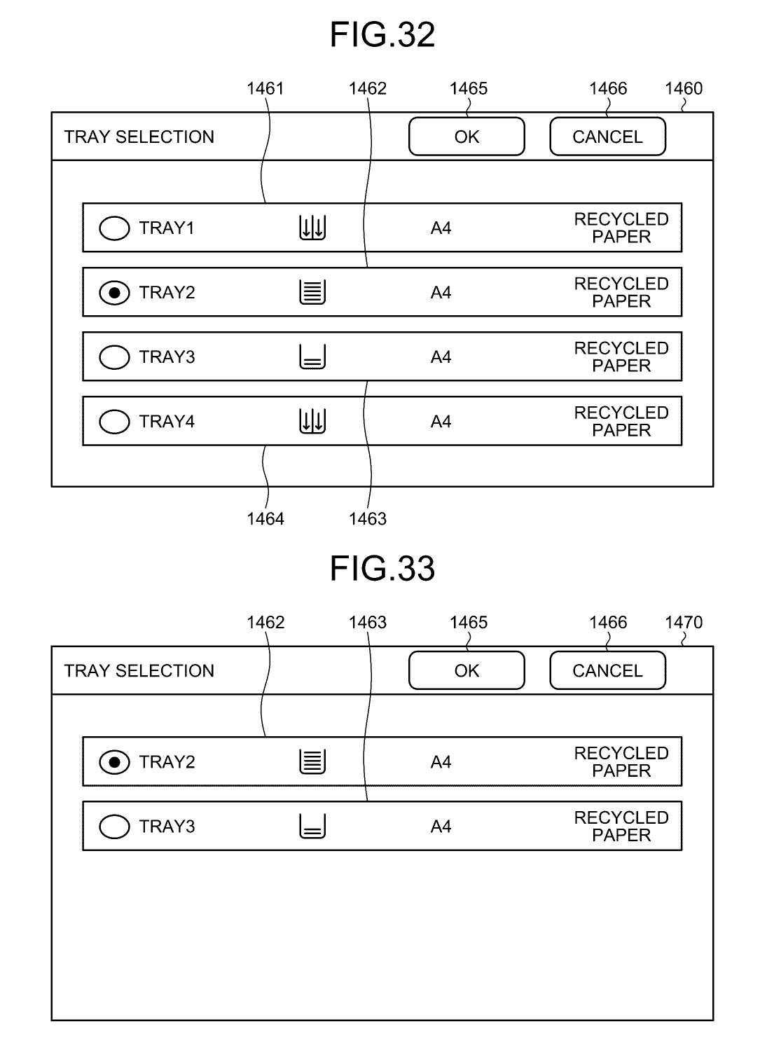

FIG. 32 illustrates a comparison example of FIG. 33, and illustrates a user setting screen 1460 in which selection keys are arranged without considering the condition information. In the example illustrated in FIG. 32, even though status of tray 1 and tray 4 in the condition information are “paper is out”, selection keys are arranged in order of a selection key 1461 to set to tray 1 that has no remaining amount of paper, a selection key 1462 to set to tray 2 that has no remaining amount of paper, a selection key 1463 to set to tray 3 that has a sufficient remaining amount of paper, and then a selection key 1464 to set to tray 4 that has no remaining amount of paper.

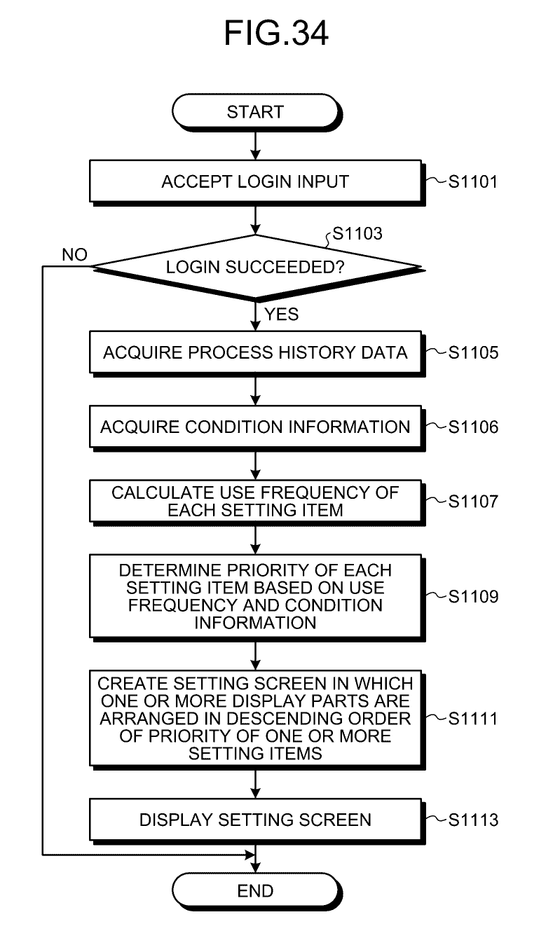

FIG. 34 is a flowchart illustrating one example of display processing performed by the operation unit 1200 of the second embodiment.

First, processing from steps S1101 to S1105 is the same as the processing at steps S101 to S105 in the flowchart illustrated in FIG. 11.

Subsequently, the condition-information acquiring unit 1273 acquires condition information from the condition-information storage unit 1271 (step S1106).

Subsequently, the use-frequency calculating unit 259 calculates a use frequency of each of one or more setting items based on the process history data acquired by the process-history-data acquiring unit 257 (step S1107).

Subsequently, the priority-order determining unit 1260 determines a priority order of each of one or more setting items based on the use frequency of each of one or more setting items calculated by the use-frequency calculating unit 259 and the condition information acquired by the condition-information acquiring unit 1273 (step S1109).

Subsequently, the screen creating unit 1263 creates a setting screen in which one or more setting items are arranged in descending order of priority in accordance with a predetermine arrangement rule (step S1111).

Subsequently, the display control unit 265 displays the setting screen created by the screen creating unit 1263 on the operation panel 205 (step S1113).

As described above, in the second embodiment, the priority order of setting items is determined considering the condition of the image processing apparatus 100. Therefore, a user can grasp the priority order among entire setting items that can be set in the setting screen 420 at a glance, and a setting item having a greater necessity to be set based on the condition of the image processing apparatus 100 can be recommended to the user.

Note that also for the second embodiment, the modifications of the first modification to the fifth modification described above can be made. Moreover, in the second embodiment, prioritization of setting items can be done using the condition information but not using the use frequency.

### (Sixth Modification)

In a sixth modification, an example of confirming, with a user, whether to arrange one or more display parts in descending order of use frequency in a setting screen in accordance with a predetermined arrangement rule is explained. Although in the sixth modification, the first embodiment described above is used to explain as an example, the second embodiment and the respective modifications described above can also be modified similarly.

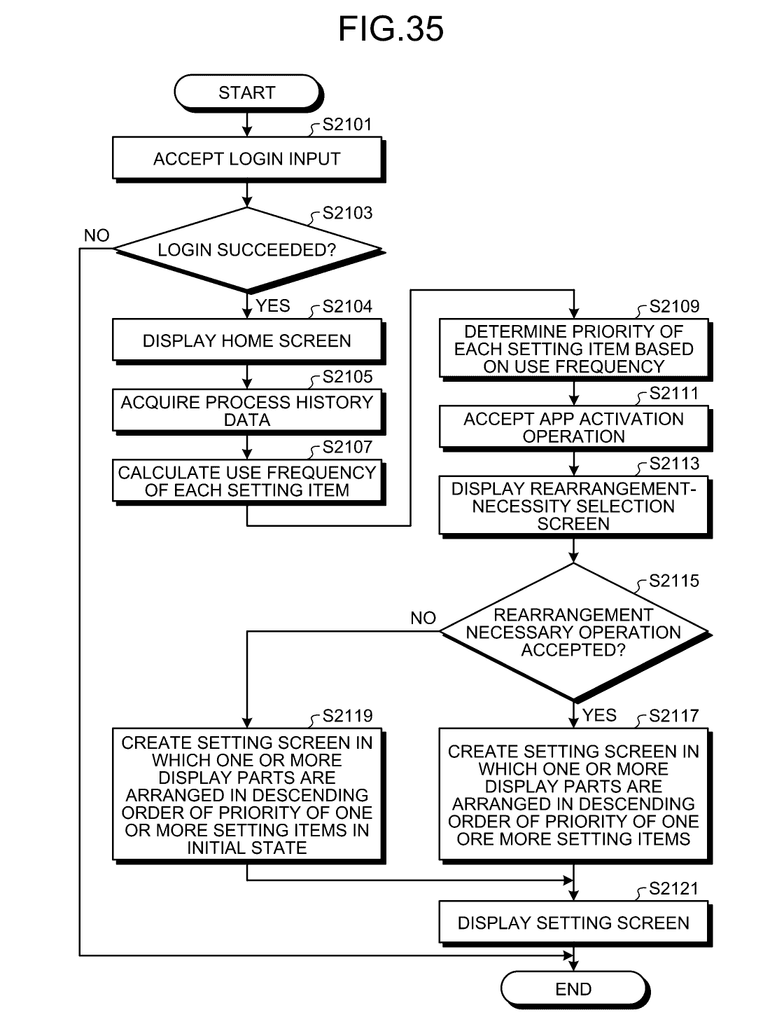

FIG. 35 is a flowchart illustrating one example of display processing performed by the operation unit 200 of the sixth modification.

First, the accepting unit 251 accepts a login input from the operation panel 205 (step S2101).

Subsequently, the authentication unit 253 performs login authentication of a user based on the login input accepted by the accepting unit 251 (step S2103). When the login authentication resulted unsuccessful (step S2103: NO), the processing is ended.

On the other hand, when the login authentication resulted successful (step S2103: YES), the screen creating unit 263 creates a home screen, and the display control unit 265 displays the home screen created by the screen creating unit 263 on the operation panel 205 (step S2104).

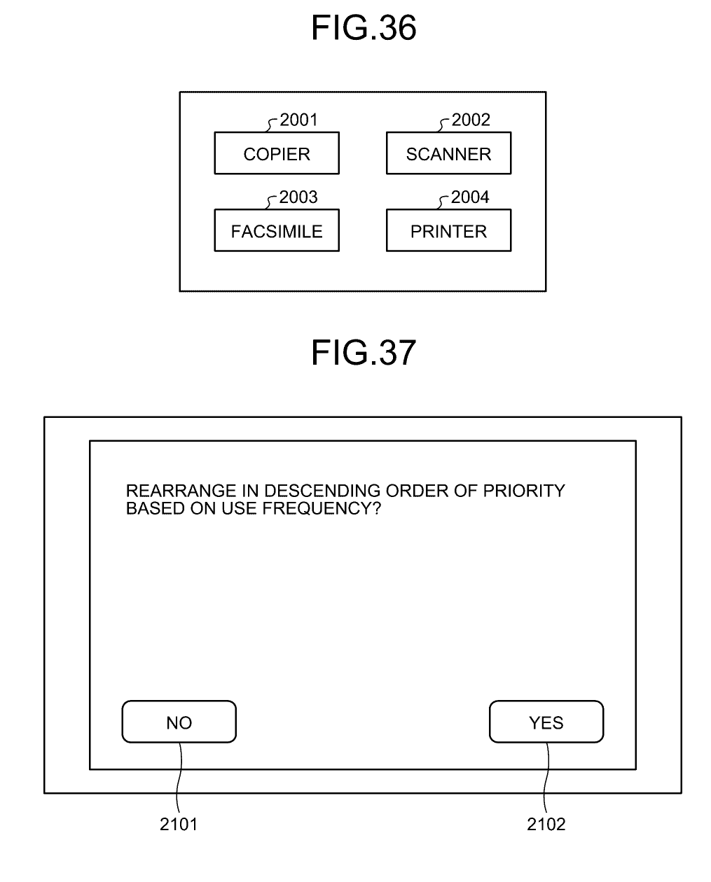

FIG. 36 illustrates one example of the home screen of the sixth modification. In the home screen illustrated in FIG. 36, a display part 2001 to activate a copier app, a display part 2002 to activate a scanner app, a display part 2003 to activate a facsimile app, and a display part 2004 to activate a printer app are arranged.

Subsequently, the process-history-data acquiring unit 257 acquires process history data that includes user identification information of the user that has passed the login authentication from the process-history-data storage unit 255 (step S2105).

Subsequently, the use-frequency calculating unit 259 calculates a use frequency of each of one or more setting items based on the process history data acquired by the process-history-data acquiring unit 257 (step S2107).

Subsequently, the priority-order determining unit 260 determines a priority of each of at least on setting items based on the use frequency of each of one or more setting items calculated by the use-frequency calculating unit 259 (step S2109).

Subsequently, the accepting unit 251 accepts, from the operation panel 205, a selection input to select the display part 2001 on the home screen as an app activation operation to activate the copier app (step S2111).

Subsequently, the screen creating unit 263 creates a rearrangement-necessity selection screen to let the user select whether rearrangement of one or more display parts to be arranged on the setting screen is necessary, and the display control unit 265 displays the rearrangement-necessity selection screen created by the screen creating unit 263 on the operation panel 205 (step S2113).

FIG. 37 illustrates one example of the rearrangement-necessity selection screen of the sixth modification. The rearrangement-necessity selection screen illustrated in FIG. 37 is a screen to let a user select whether to rearrange one or more display parts in descending order of priority of one or more setting items based on the use frequency in accordance with a predetermined arrangement rule.

Subsequently, the accepting unit 251 accepts, from the operation panel 205, a rearrangement-necessity selection input to select whether rearrangement is necessary on the rearrangement-necessity selection screen (step S2115).

Specifically, suppose the rearrangement-necessity selection input accepted by the accepting unit 251 is an operation indicating necessity of rearrangement (an operation to select a Yes key 2102 on the rearrangement-necessity selection screen) that is an input to select rearrangement necessary (step S2115: YES). In this case, the screen creating unit 263 creates a setting screen in which one or more display parts are arranged in descending order of priority of the use frequency of one or more setting items in accordance with a predetermined arrangement rule (step S2117), and the display control unit 265 displays the setting screen created by the screen creating unit 263 on the operation panel 205 (step S2121).

On the other hand, suppose that the rearrangement-necessity selection input is an operation indicating necessity of rearrangement (an operation to select a No key 2101 on the rearrangement-necessity selection screen) that is an input to select rearrangement unnecessary (step S2115: NO). In this case, the screen creating unit 263 creates a setting screen in which one or more display parts are arranged in descending order of priority of one or more setting items in the initial state in accordance with the predetermined arrangement rule (step S2119), and the display control unit 265 displays the setting screen created by the screen creating unit 263 on the operation panel 205 (step S2121).

At step S2119, the screen creating unit 263 can create a setting screen in which one or more display parts are arranged in order applied in last creation of a setting screen, not creating a setting screen in which one or more display parts are arranged in descending order of priority of at least on setting item in the initial state in accordance with the predetermined arrangement rule.

As described above, according to the sixth modification, it is possible to confirm, with a user, whether to arrange one or more display parts in descending order of the use frequency of the setting items in accordance with a predetermined arrangement rule.

Although in the sixth modification, a case in which an app activation operation is an operation to activate a copier app has been explained as an example, the sixth modification can be similarly applied to also for an operation to activate a scanner app, an operation to activate a facsimile app, and an operation to activate a printer app.

### (Seventh Modification)

In a seventh modification, an example of having a user set in advance whether to arrange one or more display parts in descending order of a use frequency of a setting item in a setting screen in accordance with a predetermined arrangement rule is explained. Although in the seventh modification, the first embodiment described above is explained as an example, the second embodiment and the respective modifications described above cam also be modified similarly.

In the seventh modification, the screen creating unit 263 creates a rearrangement-execution-mode selection screen to select a mode of rearrangement of one or more display parts that are arranged in a setting screen, and the display control unit 265 displays the rearrangement-execution-mode selection screen created by the screen creating unit 263 on the operation panel 205.

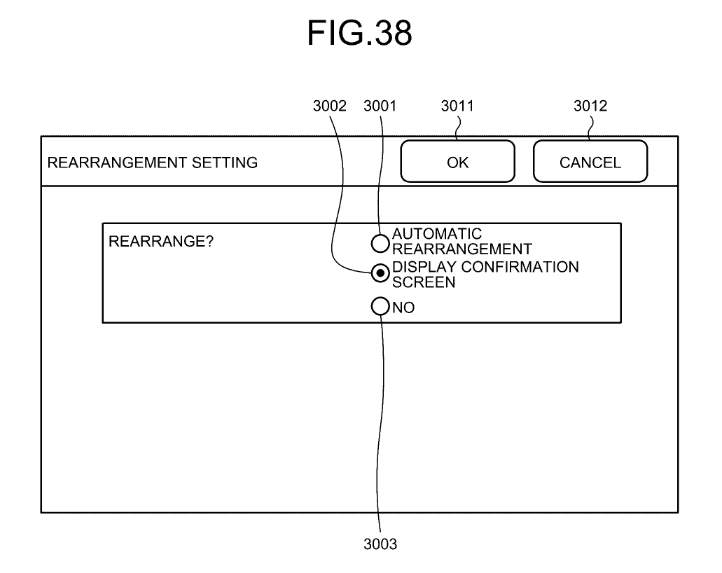

FIG. 38 illustrates one example of the rearrangement-execution-mode selection screen of the seventh modification. In the rearrangement-execution-mode selection screen illustrated in FIG. 38, a screen to let a user select a mode in which one or more display parts are rearranged in descending order of priority based on the use frequency of one or more setting items in accordance with a predetermined arrangement rule is illustrated.

The accepting unit 251 accepts, from the operation panel 205, a rearrangement-execution-mode selection input to select a mode of execution of rearrangement on the rearrangement-execution-mode selection screen. In the seventh modification, as a rearrangement-execution-mode selection input, an input to select automatic execution of rearrangement, an input to select a mode of having a user select whether rearrangement is necessary, and an input to select unnecessity of rearrangement are explained as one example, the configuration is not limited thereto.

Specifically, the input to select automatic execution of rearrangement includes an operation input to select an OK key 3011 while a toggle button 3001 is selected on the rearrangement-execution-mode selection screen illustrated in FIG. 38. Moreover, the input to select the mode of having a user select whether rearrangement is necessary includes an operation input to select the OK key 3011 while a toggle button 3002 is selected on the rearrangement-execution-mode selection screen illustrated in FIG. 38. Furthermore, the input to select unnecessity of rearrangement includes an operation input to select the OK key 3011 while a toggle button 3003 is selected on the rearrangement-execution-mode selection screen in FIG. 38.

The settings of the rearrangement execution mode selected by the rearrangement-execution-mode selection input accepted by the accepting unit 251 is stored by the screen creating unit 263 in the setting-data storage unit 267 to be managed. The screen creating unit 263 checks the settings of the rearrangement execution mode stored in the setting-data storage unit 267 at the time of creating a setting screen, and creates a setting screen in which one or more display parts are arranged in the execution mode (settings of a rearrangement execution mode) indicated by the accepted rearrangement-execution-mode selection input, and the display control unit 265 displays the setting screen created by the screen creating unit 263 on the operation panel 205.

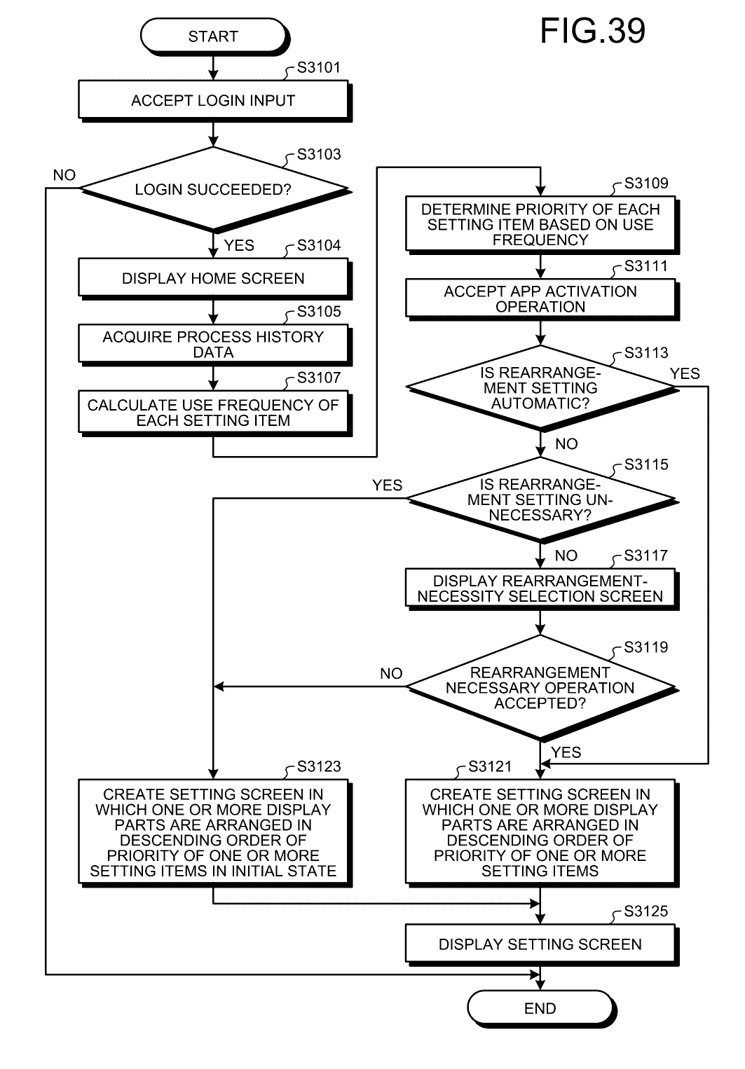

FIG. 39 is a flowchart illustrating one example of display processing performed by the operation unit 200 of the seventh modification.

First, processing at steps S3101 to S3111 is the same as the processing at steps S2101 to S2111 of the flowchart illustrated in FIG. 35. As for selection of the rearrangement execution mode described above, the selection can be done at any time as long as the selection is performed before the processing at S3111 is completed.

Subsequently, the screen creating unit 363 checks the settings of the rearrangement execution mode stored in the setting-data storage unit 267, and proceeds to step S3121 when the rearrangement execution mode is set to “automatic” that is set by an input to select automatic execution of rearrangement (step S3113: YES).

Furthermore, when the rearrangement execution mode is set to “unnecessary” (step S3113: NO, step S3115: YES), the processing proceeds to step S3123.

Moreover, when the rearrangement execution mode is set to “confirm” that is set by an input to select to let a user select whether rearrangement is necessary (step S3113: NO, step S3115: NO), the screen creating unit 263 creates the rearrangement-necessity selection screen explained in the sixth modification, and the display control unit 265 displays the rearrangement-necessity selection screen created by the screen creating unit 263 on the operation panel 205 (step S3117).

Subsequently, the accepting unit 251 accepts, from the operation panel 205, a rearrangement-necessity selection input to select whether rearrangement is necessary on the rearrangement-necessity selection screen (step S3119). When the rearrangement-necessity selection input accepted by the accepting unit 251 is a rearrangement necessary operation (an operation to select the Yes key 2102 on the rearrangement-necessity selection screen) that is an input to select rearrangement necessary (step S3119: YES), the processing proceeds to step S3121. On the other hand, when the rearrangement-necessity selection input accepted by the accepting unit 251 is rearrangement unnecessary operation (an operation to select the No key 2101 on the rearrangement-necessity selection screen) that is an input to select rearrangement unnecessary (step S3119), the processing proceeds to step S3123.

When proceeding to step S3121, the screen creating unit 263 creates a setting screen in which one or more display parts are arranged in descending order of priority based on the use frequency of one or more setting items in accordance with a predetermined arrangement rule (step S3121), and the display control unit 265 displays the setting screen created by the screen creating unit 263 on the operation panel 205 (step S3125).

On the other hand, when proceeding to step S3123, the screen creating unit 263 creates a setting screen in which one or more display parts are arranged in descending order of priority of one or more setting items in the initial state in accordance with a predetermined arrangement rule (step S3123), and displays the setting screen created by the screen creating unit 263 on the display operation panel 205 (step S3125).

At step S3123, the screen creating unit 263 can create a setting screen in which one or more display parts are arranged in order applied in last creation of a setting screen, not creating a setting screen in which one or more display parts are arranged in descending order of priority of at least on setting item in the initial state in accordance with the predetermined arrangement rule.

As described above, according to the seventh modification, it is possible to let a user set in advance whether one or more display parts are arranged in descending order of a use frequency of a setting item in accordance with a predetermined arrangement rule in a setting screen.

### (Eighth Modification)

In an eighth modification, an example of letting a user set in advance execution timing (display timing of s setting screen) of rearrangement of one or more display parts arranged in a setting screen is explained. Although in the eighth modification, the first embodiment described above is explained as an example, the second embodiment and the respective modifications (particularly the sixth and seventh modifications) can also be modified similarly.

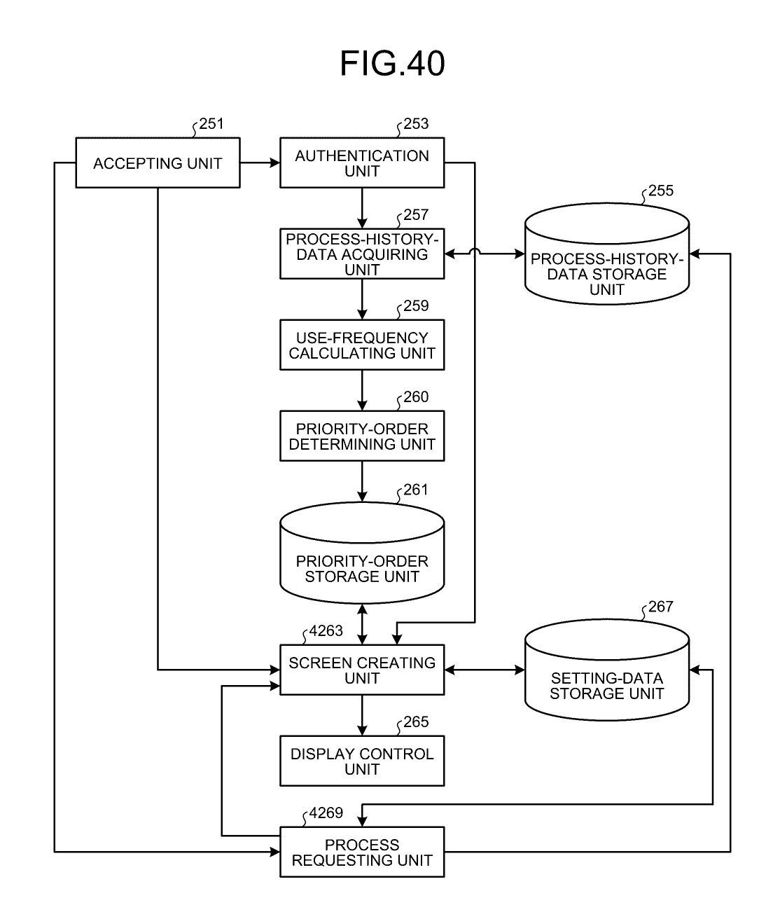

FIG. 40 is a block diagram illustrating one example of a functional configuration of an operation unit 4200 of the eighth modification. As illustrated in FIG. 40, in the eighth modification, the operation unit 4200, a screen creating unit 4263, and a process requesting unit 4269 are different from the first embodiment.

In the eighth modification, the screen creating unit 4263 creates a rearrangement-execution-timing selection screen to select execution timing for rearrangement of one or more display parts that is arranged in the setting screen, and the display control unit 265 displays the rearrangement-execution-timing selection screen created by the screen creating unit 4263 on the operation panel 205.

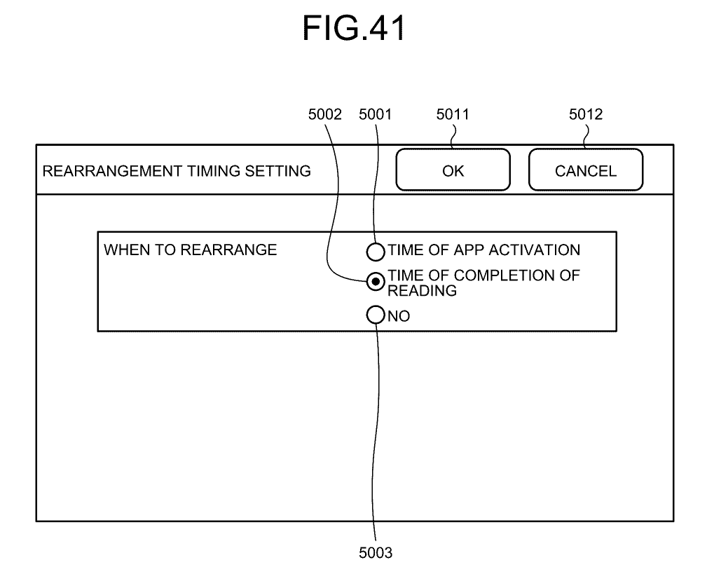

FIG. 41 illustrates one example of the rearrangement-execution-timing selection screen of the eighth modification. In the rearrangement-execution-timing selection screen illustrated in FIG. 41, a screen to let a user select timing for rearranging one or more display parts in descending order of priority based on a use frequency of at least on setting item in accordance with a predetermined arrangement rule is illustrated.

The accepting unit 251 accepts, from the operation panel, a rearrangement-execution-timing selection input to select execution timing for rearrangement on the rearrangement-execution-timing selection screen. In the eighth modification, as the rearrangement-execution-timing selection input, an input to select the time of app activation, an input to select the time of completion of reading an original, and an input to select rearrangement unnecessary are explained as one example, but the rearrangement-execution-timing selection input is not limited thereto.

Specifically, the input to select the time of app activation includes an operation input to select an OK key 5011 while a toggle button 5001 is selected on the rearrangement-execution-timing selection screen illustrated in FIG. 41. Moreover, the input to select the time of completion of reading an original includes an operation input to select the OK key 5011 while a toggle button 5002 is selected on the rearrangement-execution-timing selection screen illustrated in FIG. 41. Furthermore, the input to select rearrangement unnecessary includes an operation input to select the OK key 5011 while a toggle button 5003 is selected on the rearrangement-execution-timing selection screen illustrated in FIG. 41.

The settings of the rearrangement execution timing selected by the rearrangement-execution-timing selection input accepted by the accepting unit 251 are stored by the screen creating unit 4263 in the setting-data storage unit 267 to be managed. The screen creating unit 4263 checks the settings of the rearrangement execution timing stored in the setting-data storage unit 267, and creates a setting screen in which one or more display parts are arranged at the execution timing indicated by the accepted rearrangement-execution-timing selection input (rearrangement execution timing), and the display control unit 265 displays the setting screen created by the screen creating unit 4263 on the operation panel 205.

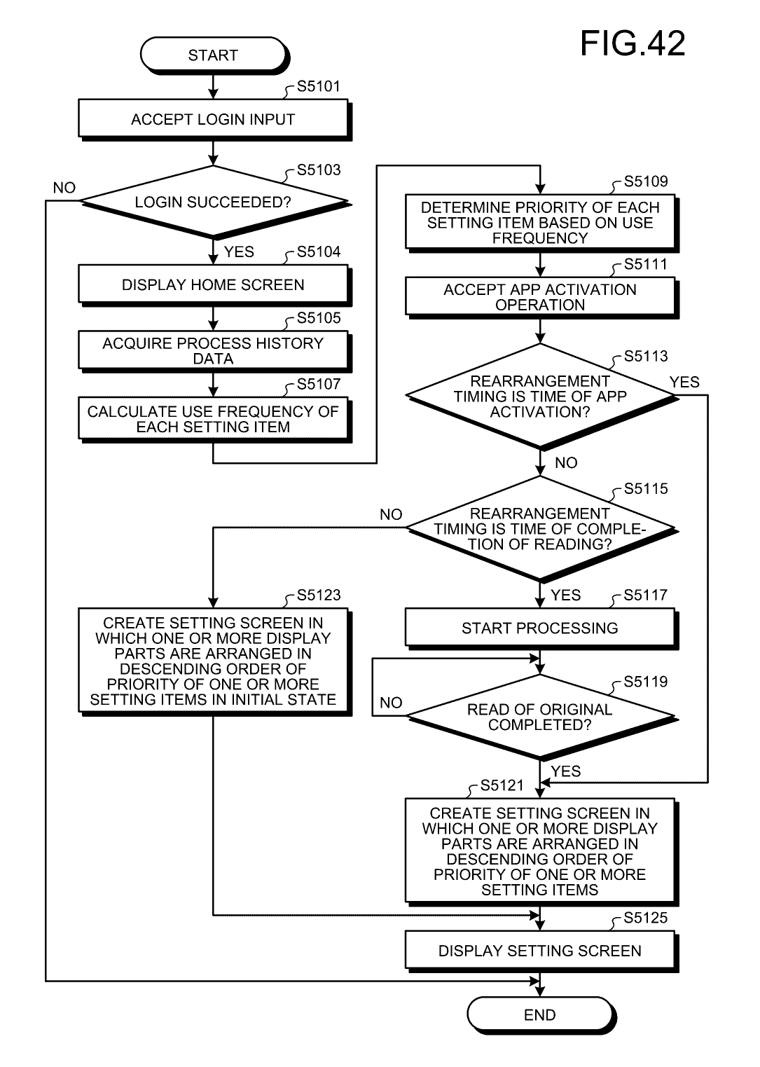

FIG. 42 is a flowchart illustrating one example of display processing performed by the operation unit 4200 of the eighth modification.

First, processing at steps S5101 to S5111 is the same as the processing at steps S2101 to S2111 in the flowchart illustrated in FIG. 35. The selection of the rearrangement execution timing described above can be done at any timing as long as the selection is performed before the processing at S5111 is completed.

Subsequently, the screen creating unit 4263 checks the setting of the rearrangement execution timing stored in the setting-data storage unit 267, and suppose that the setting of the rearrangement execution timing is “time of app activation” set by an input to select the time of app activation (step S5113: YES).

In this case, the screen creating unit 4263 creates a setting screen in which one or more display parts are arranged in descending order of priority based on the use frequency of one or more setting items in accordance with a predetermined arrangement rule (step S5121), and the display control unit 265 displays the setting screen created by the screen creating unit 4263 on the operation panel 205 (step S5125).

Moreover, suppose that the setting of the rearrangement execution timing is “unnecessary” set by an input to select the rearrangement unnecessary (step S5113: NO, step S5115: NO).

In this case, the screen creating unit 4263 creates a setting screen in which one or more display parts are arranged in descending order of priority of one or more setting items in the initial state in accordance with a predetermined arrangement rule (step S5123), and the display control unit 265 displays the setting screen created by the screen creating unit 4263 on the operation panel 205 (step S5125).

At step S5123, the screen creating unit 263 can create a setting screen in which one or more display parts are arranged in order applied in last creation of a setting screen, not creating a setting screen in which one or more display parts are arranged in descending order of priority of at least on setting item in the initial state in accordance with the predetermined arrangement rule.

Furthermore, suppose that the setting of the rearrangement execution timing is “time of completion of reading” set by an input to select the time of completion of reading an original (step S5113: NO, step S5115: YES).

In this case, the process requesting unit 4269 requests the main unit 300 to start copying (step S5117), and waits for notification that read of an original is completed from the main unit (step S5119: NO).

When the process requesting unit 4269 receives notification that read of an original is completed from the main unit 300 (step S5119: YES), the screen creating unit 4263 creates a setting screen in which one or more display parts are arranged in descending order of priority based on the use frequency of one or more setting items in accordance with a predetermined arrangement rule (step S5121), and the display control unit 265 displays the setting screen created by the screen creating unit 5263 on the operation panel 205 (step S5125).

As described above, according to the eighth modification, it is possible to let a user set in advance execution timing for rearrangement of one or more display parts that is arranged in the setting screen (display timing of a setting screen). Particularly, for a general user, what is wished to be done first when an app is activated is often execution of a job, and therefore, if the rearrangement execution timing is set to the time when read of an original is completed, it is possible to respond to a demand of a user. When the rearrangement execution timing is the time when read of an original is completed, upon completion of setting on the setting screen, the process requesting unit 4269 requests the main unit 300 to resume processing (resume copying after the original is read) based on the setting of one or more setting items set on the setting screen.

Although the eighth modification has been explained taking copying as an example, the eighth modification can be similarly applied also to other jobs if the job is a job in which read of an original is performed, such as scanning and facsimileing.

### (Ninth Modification)

In the respective embodiments and the respective modifications described above, the configuration may be such that arrangement order of display parts that are arranged in descending order of priority is changed by a user operation, or that arrangement order of display parts is stored and the display parts are thereafter arranged in the setting screen in the stored arrangement order.

### (Tenth Modification)

Although in the respective embodiment and the respective modifications described above, explanation has been given with a case in which a display part and a setting item are in one-to-one correspondence as an example, the correspondence can be one-to-two or more. Thus, a display part and print settings can be associated with each other, and a print setting having a high use frequency can be recommended to a user in priority.

### (Eleventh Modification)

Although in the respective embodiments and the respective modifications described above, an example of the image processing apparatus 100 in which the main unit 300 and the operation unit 200 are provided independently has been explained, the respective embodiments and the respective modifications are applicable also to an image processing apparatus in which the main unit 300 and the operation unit 200 are integrated (specifically, the configuration of the operation unit 200 is included in the main unit 300).

### (Twelfth Modification)

A part of the functional components of the operation unit 200 explained in the respective embodiments and the respective modifications described above can be provided to the operation unit 200 as a cloud-computing operational component, or an on-premises operational component.

### (Program)

A program that is executed by the operation unit 200 of the respective embodiments and the respective modifications described above is stored in a computer-readable recording medium such as a compact disk read-only memory (CD-ROM), a compact disk rewritable (CD-R), a memory card, a digital versatile disk, a flexible disk (FD) in a file in an installable format or an executable format to be provided.

Moreover, the program that is executed by the operation unit 200 of the respective embodiments and the respective modifications described above may be stored in a computer that is connected to a network such as the Internet, and downloaded through the network to provide the program. Furthermore, the program that is executed by the operation unit 200 of the respective embodiments and the respective modifications described above can be provided or distributed through a network such as the Internet. Moreover, the program that is executed by the operation unit 200 of the respective embodiments and the respective modifications described above can be installed in advance in a ROM and the like to be provided.

The program that is executed by the operation unit 200 of the respective embodiments and the respective modifications described above has a module structure to implement the respective components described above on a computer. As actual hardware, for example, by reading and executing the program by a CPU from a ROM, the respective functional units described above can be implemented on a computer.

According to an embodiment, an effect that a setting item that has a high possibility of being used by a user can be recommended while suppressing degradation in visibility of a setting screen is obtained.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing apparatus comprising circuitry configured to:
acquire process history data indicating a setting of one or more setting items, as a history of process executed based on the setting of the one or more setting items that are set on a setting screen in which one or more display parts to enable setting of the one or more setting items are arranged;
calculate a use frequency of each of the one or more setting items based on the acquired process history data; and
display a setting screen in which the one or more display parts are rearranged based on the use frequency of each of the one or more setting items, on a display.

2. The information processing apparatus according to claim 1, wherein the circuitry is configured to display a screen in which the one or more display parts are arranged in descending order of the use frequency of the one or more setting item in accordance with a predetermined arrangement rule on the display as the setting screen in which the one or more display parts are rearranged.

3. The information processing apparatus according to claim 1, wherein the circuitry is configured to display a screen in which the one or more display parts are arranged in order of a display part of a setting item having a use frequency that exceeds a threshold, and then a display part of a setting item having a use frequency that is equal to or lower than the threshold, in accordance with a predetermined arrangement rule, as the setting screen in which the one or more display parts are rearranged.

4. The information processing apparatus according to claim 1, wherein the circuitry is configured to display a screen in which a display part of a setting item having a use frequency that exceeds a threshold out of the one or more display parts are arranged in accordance with a predetermined arrangement rule on the display as the setting screen in which the one or more display parts are rearranged.

5. The information processing apparatus according to claim 4, wherein the circuitry is configured to display a screen in which display parts of setting items having use frequencies that exceed the threshold out of the one or more display parts are arranged in descending order of the use frequencies of the setting items in accordance with a predetermined arrangement rule on the display as the setting screen in which the one or more display parts are rearranged.

6. The information processing apparatus according to claim 4, wherein the circuitry is further configured to:
display a selection screen to enable selection of at least one display part of at least one setting item having a use frequency that is equal to or lower than the threshold out of the one or more display parts, on the display; and
accept a selection input to select either one of the at least one display part of the at least one setting item having the use frequency that is equal to or lower than the threshold on the selection screen, and
the circuitry is configured to display a screen in which the display part of the setting item having the use frequency that exceeds the threshold, and then the display part for which the selection input has been accepted, out of the one or more display parts, are arranged in accordance with the arrangement rule on the display as the setting screen in which the one or more display parts are rearranged.

7. The information processing apparatus according to claim 1, wherein the circuitry is further configured to acquire condition information relating to condition of an image processing apparatus that is equipped with the information processing apparatus, and
the circuitry is configured to display the setting screen in which the one or more display parts are rearranged based on the use frequency of each of the one or more setting items and the acquired condition information, on the display.

8. The information processing apparatus according to claim 1, wherein the circuitry is configured to:
acquire the process history data of the information processing apparatus, and process history data of at least one other information processing apparatus; and
calculate the use frequency of each of the one or more setting items based on the acquired process history data.

9. The information processing apparatus according to claim 1, wherein the circuitry is further configured to:
display a rearrangement-necessity selection screen to enable selecting whether rearrangement of the one or more display parts are necessary, on the display; and
accept, on the rearrangement-necessity selection screen, a rearrangement-necessity selection input to select whether rearrangement is necessary, and
the circuitry is configured to display the setting screen in which the one or more display parts are rearranged based on the use frequency of each of the one or more setting items if the accepted rearrangement-necessity selection input is an input to select that rearrangement is necessary.

10. The information processing apparatus according to claim 1, wherein the circuitry is further configured to:
display a rearrangement-execution-mode selection screen to enable selecting an execution mode of rearrangement of the one or more display parts on the display; and
accept a rearrangement-execution-mode selection input to select an execution mode of rearrangement on the rearrangement-execution-mode selection screen, and
the circuitry is configured to display the setting screen in which the one or more display parts are arranged in the execution mode indicated by the accepted rearrangement-execution-mode selection input on the display.

11. The information processing apparatus according to claim 10, wherein the circuitry is configured to display, if the accepted rearrangement-execution-mode selection input is an input to select automatic execution of rearrangement, the setting screen in which the one or more display parts are rearranged based on the use frequency of each of the one or more setting items.

12. The information processing apparatus according to claim 10, wherein the circuitry is further configured to:
display, if the accepted rearrangement-execution-mode selection input is an input to let a user select whether rearrangement is necessary, a rearrangement-necessity selection screen to enable selecting whether rearrangement of the one or more display parts is necessary on the display, and
accepts a rearrangement-necessity selection input to select whether rearrangement is necessary on the rearrangement-necessity selection screen, and
the circuitry is configured to display, if the accepted rearrangement-necessity selection input is an input to select that rearrangement is necessary, the setting screen in which the one or more display parts are rearranged based on the use frequency of each of the one or more setting items on the display.

13. The information processing apparatus according to claim 1, wherein the circuitry is further configured to:
display a rearrangement-execution-timing selection screen to select execution timing of rearrangement of the one or more display parts on the display; and
accept a rearrangement-execution-timing selection input to select execution timing of rearrangement on the rearrangement-execution-timing selection screen, and
the circuitry is configured to display the setting screen in which the one or more display parts are rearranged based on the use frequency of each of the one or more setting items at execution timing indicated by the accepted rearrangement-execution-timing selection input on the display.

14. The information processing apparatus according to claim 13, wherein the execution timing indicated by the accepted rearrangement-execution-timing selection input comprises time when an application is activated.

15. The information processing apparatus according to claim 13, wherein
the setting screen is a screen to make settings of at least either one of copying, scanning, and facsimileing, and
the execution timing indicated by the accepted rearrangement-execution-timing selection input comprises time when read of original is completed.

16. The information processing apparatus according to claim 1, wherein the use frequency is number of times when processing is performed with a setting value of the setting item that is set to a value different from an initial value of the setting item.

17. An image processing apparatus comprising the information processing apparatus according to claim 1.

18. An information processing system comprising an information processing apparatus, and a main apparatus configured to communicate with the information processing apparatus, the information processing apparatus comprising circuitry configured to:
acquire process history data indicating a setting of one or more setting items, as a history of process executed based on the setting of the one or more setting items that are set on a setting screen in which one or more display parts to enable setting of the one or more setting items are arranged;
calculate a use frequency of each of the one or more setting items based on the acquired process history data; and
display a setting screen in which the one or more display parts are rearranged based on the use frequency of each of the one or more setting items, on a display.

19. A screen display method comprising:
acquiring process history data indicating a setting of one or more setting items, as a history of process executed based on the setting of the one or more setting items that are set on a setting screen in which one or more display parts to enable setting of the one or more setting items are arranged;
calculating a use frequency of each of the one or more setting items based on the acquired process history data; and
displaying a setting screen in which the one or more display parts are rearranged based on the use frequency of each of the one or more setting items, on a display.
